(19) United States
(12) Patent Application Publication
(10) Pub. No.: US 2019/0203120 A1
(43) Pub. Date: Jul. 4, 2019

(54) LIQUID CRYSTAL COMPOSITION AND LIQUID CRYSTAL DISPLAY DEVICE

(71) Applicant: DIC Corporation

(72) Inventors: Go Sudo, Kitaadachi-gun (JP); Shinichi Hirata, Kitaadachi-gun (JP); Marina Goto, Kitaadachi-gun (JP)

(73) Assignees: DIC Corporation, Tokyo (JP); DIC Corporation, Tokyo (JP)

(21) Appl. No.: 16/304,948

(22) PCT Filed: Nov. 9, 2017
(86) PCT No.: PCT/JP2017/040370

§ 371 Date: Nov. 27, 2018

(30) Foreign Application Priority Data
Nov. 22, 2016 (JP) 2016-226745

(51) Int. Cl. C09K 19/44; C09K 19/12; C09K 19/30

(52) U.S. Cl. CPC C09K 19/44; C09K 19/12; C09K 19/3003; C09K 19/3098; C09K 19/3066; C09K 2019/3016; C09K 2019/123; C09K 2019/3004; C09K 2019/3009; C09K 2019/301; C09K 2019/122

(57) ABSTRACT

A problem to be solved by the present invention is to provide a liquid crystal composition containing a polymerizable compound for producing a VA-mode, PSA-mode, or PSVA-mode liquid crystal display device which has large K₃₃, small γ₁/K₃₃, high VHR after ultraviolet irradiation, a high polymerization rate of the polymerizable compound, no or very few display defects due to a change in pretilt angle, a satisfactory pretilt angle, and excellent response performance, and also to provide a liquid crystal display device using the liquid crystal composition. The problem is solved by a liquid crystal composition of the present invention containing a compound of formula (B31) and a compound of formula (CB31).

### TECHNICAL FIELD

The present invention relates to a liquid crystal composition and a liquid crystal display device using the same.

### BACKGROUND ART

Liquid crystal display devices are used for watches and electronic calculators, various household electric appliances, measuring apparatuses, automotive panels, word processors, electronic notebooks, printers, computers, televisions, etc. Typical examples of a liquid crystal display mode include a TN (twisted nematic) mode, a STN (super twisted nematic) mode, a DS (dynamic scattering) mode, a GH (guest-host) mode, an IPS (in-plane switching) mode, an OCB (optically compensated birefringence) mode, an ECB (electrically controlled birefringence) mode, a VA (vertical alignment) mode, a CSH (color super-homeotropic) mode, a FLC (ferroelectric liquid crystal) mode, and the like. Examples of a driving method include static driving, multiplex driving, a simple matrix method, and an active matrix (AM) method of driving by using TFT (thin-film transistor), TFD (thin-film diode) or the like. Among these display modes, the IPS mode, the ECB mode, the VA mode, the CSH mode, or the like is characterized by using a liquid crystal composition showing a negative value of Δε (dielectric anisotropy). Among these, in particular, the VA display mode using AM driving is used for application such as display devices, for example, a television, a monitor, and the like, which require fast response and a wide viewing angle.

A liquid crystal composition disclosed as a liquid crystal composition having negative ×ε uses liquid crystal compounds (A) and (B) (refer to Patent Literature 1) having a 2,3-difluorophenylene skeleton as shown below.

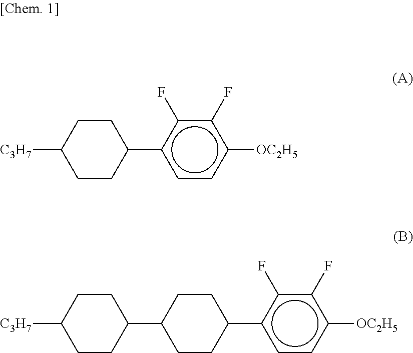

The liquid crystal composition uses liquid crystal compounds (C) and (D) as liquid crystal compounds having substantially zero Δε, but satisfactorily low viscosity is not yet realized with the liquid crystal composition for a liquid crystal television and the like which are required to have fast response.

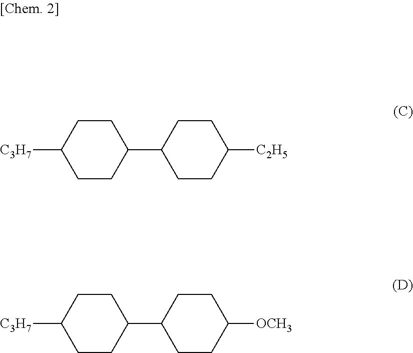

On the other hand, a liquid crystal composition using a liquid crystal compound (E) is already disclosed, but there are introduced a liquid crystal composition combined with the liquid crystal compound (D) and having low refractive index anisotropy Δn (refer to Patent Literature 2) and a liquid crystal composition containing a liquid crystal compound (F) added for improving the response speed (refer to Patent Literature 3).

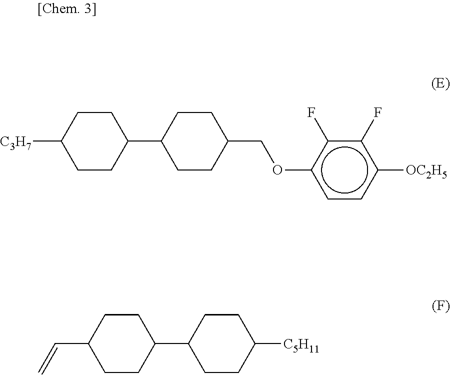

Also, a liquid crystal composition using a liquid crystal compound (G) and a liquid crystal compound (F) is already disclosed (refer to Patent Literature 4), but faster response is required.

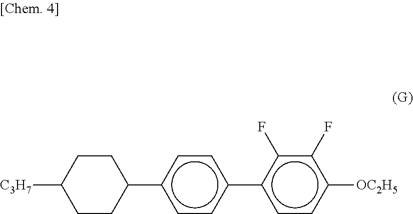

Further, there is disclosed a liquid crystal composition containing the liquid crystal compound (A) and the liquid crystal compound (G) used in combination with a liquid crystal compound having substantially zero Δε and represented by formula (I) (refer to Patent Literature 5).

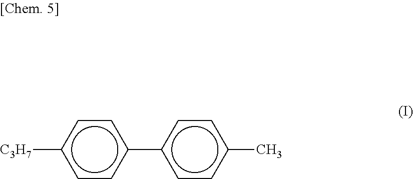

However, any one of these liquid crystal compositions cannot satisfy both the response speed and reliability required, particularly, for a large liquid crystal display device. On the other hand, Patent Literature 6 discloses that the response speed of a homeotropic liquid crystal cell is improved by using a liquid crystal material having a large index represented by (Formula 1). However, the improvement cannot be said satisfactory,

### [Math. 1]

FoM=K₃₃Δn²/γ1 (Formula 1)

K₃₃=elastic constant

Δn=refractive index anisotropy

γ1=rotational viscosity

Therefore, a liquid crystal composition for a liquid crystal television and the like which require fast response is required to be sufficiently decreased in viscosity (η), sufficiently decreased in rotational viscosity (γ₁), and increased in elastic constant (K₃₃) without being decreased in refractive index anisotropy (Δn) and nematic phase-isotropic liquid phase transition temperature (Tₙᵢ). Also, a PSA (Polymer Sustained Alignment)-mode liquid crystal display device, which has recently been developed, has a structure in which a polymer structure is formed in a cell in order to control the pretilt angle of liquid crystal molecules, and in view of the fast response and high contrast, development and improvement are advanced as a liquid crystal display device mainly for televisions.

The PSA-mode liquid crystal display device is produced by injecting a liquid crystal composition containing a polymerizable compound between substrates and polymerizing the polymerizable compound and fixing the alignment of liquid crystal molecules by irradiation with ultraviolet light in a state where liquid crystal molecules are aligned by applying a voltage. In this case, the polymerization rate of the polymerizable compound is very important. With a moderately high polymerization rate, the amount of polymerizable compound remaining with a short ultraviolet irradiation time is decreased, and thus deterioration or the like in peripheral members such as the liquid crystal composition little occurs due to ultraviolet light. With a low polymerization rate of the polymerizable compound, long-time irradiation with strong ultraviolet light is required for decreasing the amount of polymerizable compound remaining, thereby causing an increase in size of a manufacturing apparatus, a decrease in manufacturing efficiency, and deterioration or the like in peripheral members such as the liquid crystal composition due to ultraviolet light. When the amount of the polymerizable compound remaining is increased for the reason of the short ultraviolet irradiation time, the occurrence of image-sticking, which is a display defect, due to the remaining polymerizable compound cannot be avoided.

From the above, a liquid crystal composition used for the PSA-mode liquid crystal display device is required to cause no deterioration or substantially no deterioration due to ultraviolet irradiation and is also required not to cause image-sticking and to have fast response when used in a liquid crystal display device.

### CITATION LIST

### Patent Literature

PTL 1: Japanese Unexamined Patent Application Publication No. 8-104869

PTL 2: European Patent Application Publication No. 0474062

PTL 3: Japanese Unexamined Patent Application Publication No. 2006-037054

PTL 4: Japanese Unexamined Patent Application Publication No. 2001-354967

PTL 5: International Publication No. W02012/137810

PTL 6: Japanese Unexamined Patent Application Publication No. 2006-301643

### SUMMARY OF INVENTION

### Technical Problem

A problem to be solved by the present invention is to provide a liquid crystal composition or a liquid crystal composition containing a polymerizable compound, which has large K₃₃, small γ₁/K₃₃, high VHR after ultraviolet irradiation, and a high polymerization rate of the polymerizable compound and which is used for producing a PSA-mode or PSVA-mode liquid crystal display device having no or very few display defects due to a change in pretilt angle and having a satisfactory pretilt angle and excellent response performance, and also to provide a liquid crystal display device using the same.

### Solution to Problem

As a result of earnest investigation, the inventors of the present invention found that the problem can be solved by a liquid crystal composition containing a combination of a compound having a specified chemical structure and a polymerizable compound, leading to the achievement of the present invention.

### Advantageous Effects of Invention

A liquid crystal composition of the present invention is a liquid crystal composition which shows low rotational viscosity (γ₁), and high elastic constant (K₃₃) with substantially no decrease in refractive index anisotropy (Δn) and nematic phase-isotropic liquid phase transition temperature (Tₙᵢ), and which has a low value of γ₁/K₃₃ and a high polymerization rate of a polymerizable compound during ultraviolet irradiation. In addition, a liquid crystal display device using the liquid crystal composition of the present invention exhibits a satisfactory pretilt angle, a high voltage holding ratio (VHR), and fast response, and has no or suppressed alignment defect and display defects, such as image-sticking and the like, and a small amount of the polymerizable compound remaining when containing the polymerizable compound, and shows excellent display quality with substantially no adverse effect on a liquid crystal display device.

When the liquid crystal composition of the present invention contains a polymerizable compound, it is possible to provide an excellent PSA-mode or PSVA-mode liquid crystal display device having a satisfactory pretilt angle imparted after polymerization without inhibiting the polymerizability of the polymerizable compound and having no or very few display defects due to the remaining polymerizable compound and a change in pretilt angle. Therefore, a liquid crystal display device using the liquid crystal composition of the present invention is very useful.

### DESCRIPTION OF EMBODIMENTS

A liquid crystal composition of the present invention contains, as essential components, a compound of formula (B31) and a compound of formula (CB31).

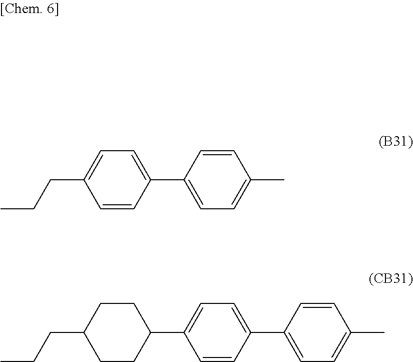

In addition, a liquid crystal display device uses the liquid crystal composition.

The lower limit value of the content of the compound of the formula (B31) in the liquid crystal composition of the present invention is preferably 3% by mass, more preferably 5% by mass, and still more preferably 7% by mass, and the upper limit value is preferably 25% by mass, more preferably 20% by mass, more preferably 18% by mass, more preferably 15% by mass, more preferably 13% by mass, and still more preferably 11% by mass. The range of the content is preferably 3% to 25% by mass, more preferably 5% to 20% by mass, and still more preferably 5% to 15% by mass.

The lower limit value of the content of the compound of the formula (CB31) in the liquid crystal composition of the present invention is preferably 2% by mass, more preferably 3% by mass, still more preferably 5% by mass, and still more preferably 8% by mass, and the upper limit value is preferably 15% by mass, more preferably 13% by mass, and still more preferably 11% by mass. The range of the content is preferably 2% to 15% by mass, more preferably 2% to 13% by mass, and still more preferably 2% to 11% by mass.

In addition to the compound of the formula (B31) and the compound of the formula (CB31), the liquid crystal composition of the present invention preferably contains one or two or more compounds selected from a compound group represented by general formulae (N-01), (N-02), (N-03), and (N-04). These compounds correspond to compounds having negative dielectric anisotropy. These compounds show a negative sign of Δε and its absolute value more than 2. In addition, Δε of a compound is a value extrapolated from the measured value of dielectric anisotropy of a composition prepared by adding the compound to a composition substantially dielectrically neutral at 25° C.

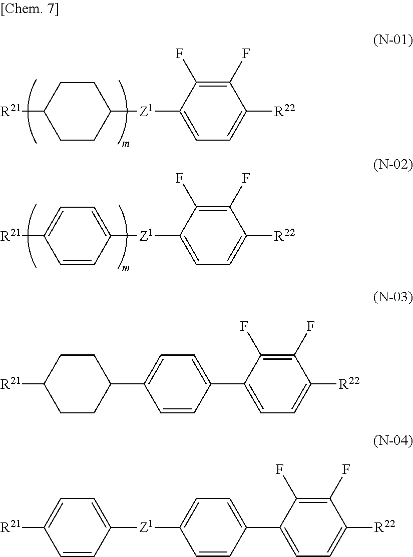

In the formulae, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—; and m each independently represent 1 or 2.

R²¹ is preferably an alky group having 1 to 8 carbon atoms, more preferably an alkyl group having 1 to 5 carbon atoms, and still more preferably an alkyl group having 1 to 4 carbon atoms. However, when Z¹ represents other than a single bond, R²¹ is preferably an alkyl group having 1 to 3 carbon atoms.

R²² is preferably an alky group having 1 to 8 carbon atoms or alkoxy group having 1 to 8 carbon atoms, more preferably an alkyl group having 1 to 5 carbon atoms or an alkoxy group having 1 to 4 carbon atoms, and still more preferably an alkoxy group having 1 to 4 carbon atoms.

R²¹ and R²² may be each an alkenyl group and are each preferably selected from groups represented by formula (R1) to formula (R5) (in each of the formulae, a black point represents a carbon atom in a ring structure), and the formula (R1) or formula (R2) is preferred. The content of a compound having an alkenyl group as each of R²¹ and R²² is preferably as low as possible, and such a compound is often preferably not contained.

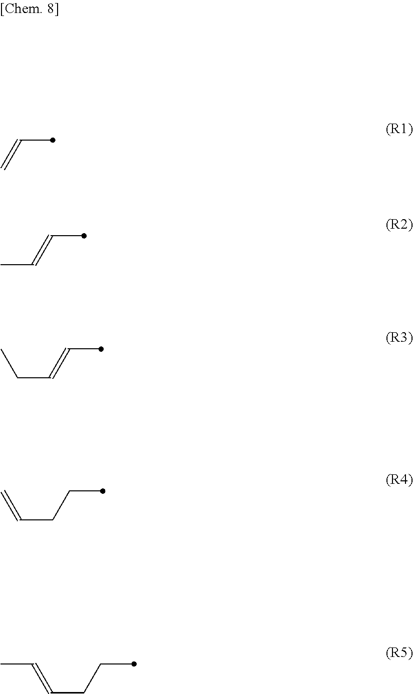

Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—, but is preferably a single bond, —CH₂CH₂—, —OCH₂—, or —CH₂O—, more preferably a single bond or —CH₂O—, and still more preferably a single bond.

In addition, m is preferably 1.

A fluorine atom in a compound represented by each of the general formulae (N-01), (N-02), (N-03), and (N-04) may be substituted by a chlorine atom in the same halogen group. However, the content of a compound substituted by a chlorine atom is preferably as low as possible, and such a compound is more preferably not contained.

A hydrogen atom in a ring of a compound represented by each of the general formulae (N-01), (N-02), (N-03), and (N-04) may be further substituted by a fluorine atom or a chlorine atom. However, the content of a compound substituted by a chlorine atom is preferably as low as possible, and such a compound is more preferably not contained.

The compound represented by each of the general formulae (N-01), (N-02), (N-03), and (N-04) is preferably a compound having negative Δε and its absolute value more than 3.

A compound contained as the compound represented by the general formula (N-01) is preferably one or two or more compounds selected from a compound group represented by general formula (N-01-1), general formula (N-01-2), general formula (N-01-3), and general formula (N-01-4). Among these compounds, a compound represented by the general formula (N-01-1) or general formula (N-01-4) is more preferred. When higher VHR and high reliability are required, a compound represented by the general formula (N-01-3) is preferably not contained.

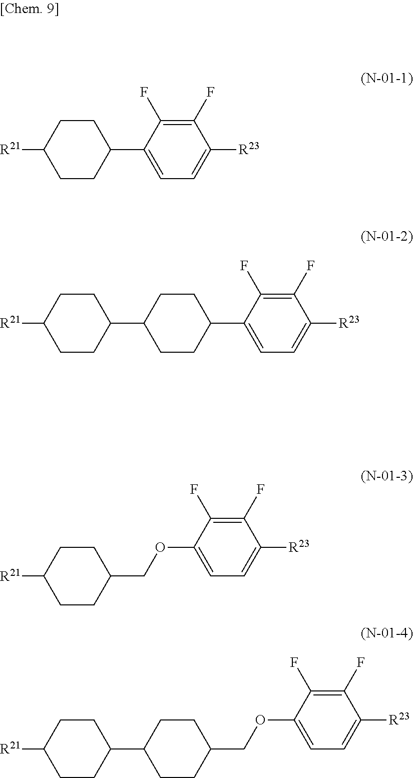

In the formulae, R²¹ represents the same meaning as described above, and R²³ each independently represent an alkoxy group having 1 to 4 carbon atoms.

A compound contained as the compound represented by the general formula (N-02) is preferably one or two or more compounds selected from a compound group represented by general formula (N-02-1), general formula (N-02-2), and general formula (N-02-3). Among these compounds, a compound represented by the general formula (N-02-1) or general formula (N-02-3) is more preferred, and a compound represented by the general formula (N-02-1) is particularly preferred. It is particularly preferred to combine a compound represented by the general formula (N-01-4) with a compound represented by the general formula (N-02-1).

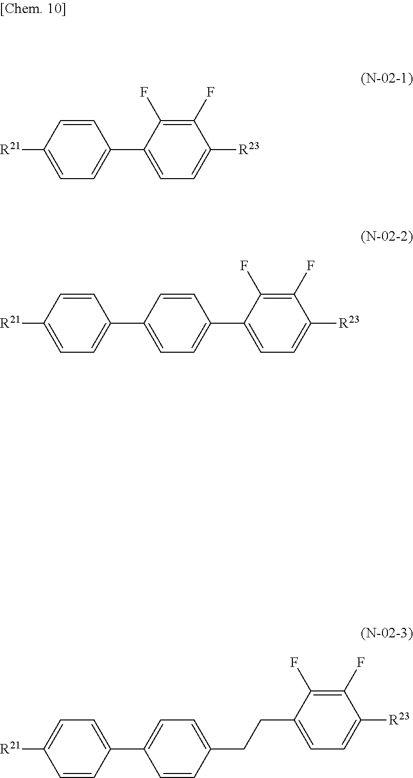

In the formulae, R²¹ represents the same meaning as described above, and R²³ each independently represent an alkoxy group having 1 to 4 carbon atoms.

A compound contained as the compound represented by the general formula (N-03) is preferably one or two or more compounds represented by general formula (N-03-1).

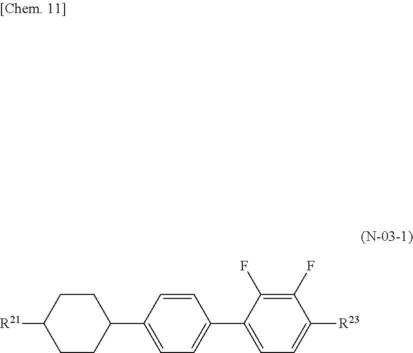

In the formula, R²¹ represents the same meaning as described above, and R²³ represents an alkoxy group having 1 to 4 carbon atoms.

It is particularly preferred to combine a compound represented by the general formula (N-01-4) with a compound represented by the general formula (N-02-1) and a compound represented by the general formula (N-03-1).

A compound contained as the compound represented by the general formula (N-04) is preferably one or two or more compounds represented by general formula (N-04-1).

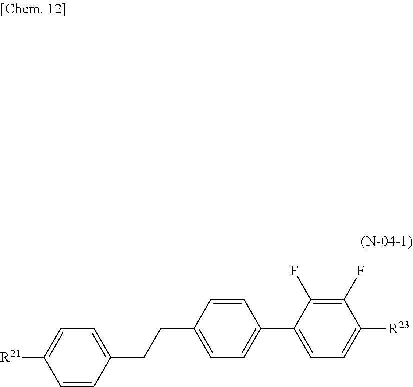

In the formula, R²¹ represents the same meaning as described above, and R²³ represents an alkoxy group having 1 to 4 carbon atoms.

In the liquid crystal composition of the present invention, the total content of compounds selected from the compound group represented by the general formula (N-01), the general formula (N-02), the general formula (N-03), and the general formula (N-04) is preferably 10% by mass to 80% by mass, preferably 20% by mass to 75% by mass, preferably 30% by mass to 73% by mass, or preferably 35% by mass to 70% by mass. Although the content is described by “%” below, this represents “% by mass”.

The lower limit value of the preferred content of a compound represented by the general formula (N-01) relative to the total amount of the liquid crystal composition of the present invention is 0%, 1%, 5%, 10%, 20%, 30%, 40%, 50%, 55%, 60%, 65%, 70%, 75%, or 80%. The upper limit value of the preferred content is 95%, 85%, 75%, 65%, 55%, 45%, 35%, 25%, 20%, 15%, or 10%.

The lower limit value of the preferred content of a compound represented by the general formula (N-02) relative to the total amount of the liquid crystal composition of the present invention is 0%, 1%, 5%, 10%, 20%, 30%, 40%, 50%, 55%, 60%, 65%, 70%, 75%, or 80%. The upper limit value of the preferred content is 95%, 85%, 75%, 65%, 55%, 45%, 35%, 25%, 20%, 15%, or 10%.

The lower limit value of the preferred content of a compound represented by the general formula (N-03) relative to the total amount of the liquid crystal composition of the present invention is 0%, 1%, 5%, 10%, 20%, 30%, 40%, 50%, 55%, 60%, 65%, 70%, 75%, or 80%. The upper limit value of the preferred content is 95%, 85%, 75%, 65%, 55%, 45%, 35%, 25%, 20%, 15%, or 10%.

The lower limit value of the preferred content of a compound represented by the general formula (N-04) relative to the total amount of the liquid crystal composition of the present invention is 0%, 1%, 5%, 10%, 20%, 30%, 40%, 50%, 55%, 60%, 65%, 70%, 75%, or 80%. The upper limit value of the preferred content is 95%, 85%, 75%, 65%, 55%, 45%, 35%, 25%, 20%, 15%, or 10%.

The liquid crystal composition of the present invention preferably contains a total of 10% to 80% of compounds selected from the compound group represented by the general formula (N-01-1), the general formula (N-01-4), the general formula (N-02-1), and the general formula (N-03-1).

In order to keep the rotational viscosity (γ₁) low in the liquid crystal composition of the present invention and to produce a liquid crystal display device having high response speed, the lower limit value is preferably low, and the upper limit value is preferably low. Also, in order to increase the dielectric anisotropy (Δε) for keeping the drive voltage low, the lower limit value is preferably high, and the upper limit value is preferably high.

The liquid crystal composition of the present invention may further contain one or two or more compounds represented by general formula (N-05).

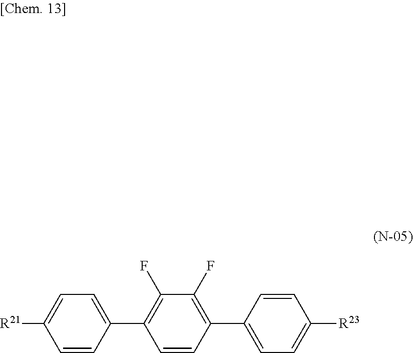

(In the formula, R²¹ and R²² each represent the same meaning as described above, but when R²¹ and R²² each represent an alkenyl group, the formula (R4) or the formula (R5) is preferred.)

A compound represented by the general formula (N-05) is effective for when various physical properties are desired to be adjusted, and can be used, particularly, for achieving high refractive index anisotropy (≢n).

The lower limit value of the preferred content of a compound represented by the general formula (N-05) relative to the total amount of the liquid crystal composition of the present invention is 0%, 2%, 5%, 8%, 10%, 13%, 15%, 17%, or 20%. The upper limit value of the preferred content is 30%, 28%, 25%, 23%, 20%, 18%, 15%, or 13%.

The compound represented by the general formula (N-05) is preferably a compound selected from a compound group represented by formula (N-05-1) to formula (N-05-3).

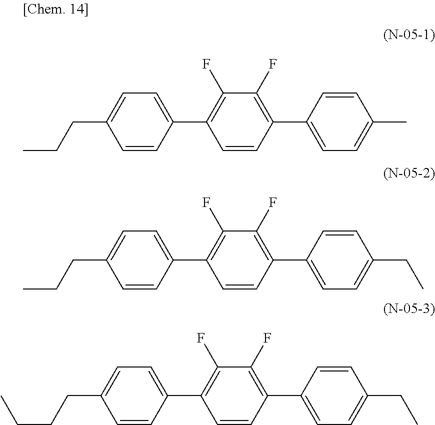

The liquid crystal composition of the present invention may further contain one or two or more compounds represented by general formula (N-06).

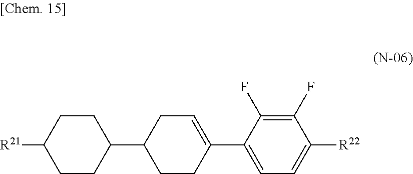

(In the formula, R²¹ and R²² each represent the same meaning as described above.)

A compound represented by the general formula (N-06) is effective for when various physical properties are desired to be adjusted, and can be used for achieving particularly high refractive index anisotropy (Δn), high T, and large Δε.

The lower limit value of the preferred content of a compound represented by the general formula (N-06) relative to the total amount of the liquid crystal composition of the present invention is 0%, 2%, 5%, 8%, 10%, 13%, 15%, 17%, or 20%. The upper limit value of the preferred content is 30%, 280, 250, 230, 200, 180, 150, 130, 100, or 50.

The liquid crystal composition of the present invention preferably contains one or two or more compounds selected from a compound group represented by general formula (NU-01) to general formula (NU-06).

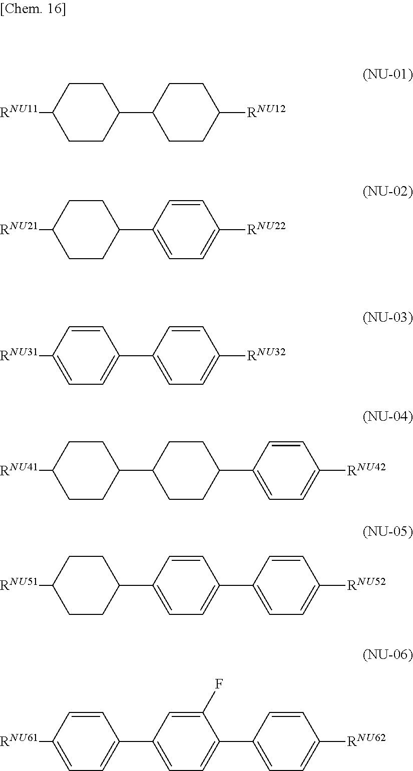

In the formulae, R^{NU11}, R^{NU12}, R^{NU21}, R^{NU22}, R^{NU31}, R^{NU41}, R^{NU42}, R^{NU51}, R^{NU61}, and R^{NU62} each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; and R^{NU32} and R^{NU52} each independently represent an alkyl group having 2 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—. In addition, R^{NU11}, R^{NU12}, R^{NU21} , R^{Nu22}, R^{NU31}, R^{NU41}, R^{NU42}, R^{NU51}, R^{NU61}, and R^{NU62} are each preferably an alkyl group having 1 to 5 carbon atoms or an alkoxy group having 1 to 5 carbon atoms and more preferably an alkyl group having 1 to 5 carbon atoms; and R^{NU32} and R^{NU52} are each preferably an alkyl group having 2 to 5 carbon atoms or an alkoxy group having 1 to 5 carbon atoms and more preferably an alkyl group having 2 to 5 carbon atoms.

The content of a compound having an alkenyl group as each of R^{NU11}, R^{NU12}, R^{NU21}, R^{NU22}, R^{NU31}, R^{NU32}, R^{NU41}, R^{NU42}, R^{NU51}, R^{NU52}, R^{NU61}, and R^{NU62} i preferably as low as possible, and such a compound is often preferably not contained.

The liquid crystal composition preferably contains a compound represented by the general formula (NU-01) or the general formula (NU-02) in the compound group represented by the general formula (NU-01) to the general formula (NU-06), and particularly preferably contains a compound represented by the general formula (NU-01).

The content of the compound represented by the general formula (NU-01) is preferably 5% to 60% by mass, more preferably 10% to 50% by mass, and still more preferably 15% to 40% by mass.

The content of the compound represented by the general formula (NU-02) is preferably 3% to 30% by mass, more preferably 5% to 25% by mass, and still more preferably 5% to 20% by mass.

The content of the compound represented by the general formula (NU-03) is preferably 0% to 20% by mass, more preferably 0% to 15% by mass, and still more preferably 0% to 10% by mass.

The content of the compound represented by the general formula (NU-04) is preferably 3% to 30% by mass, more preferably 3% to 20% by mass, and still more preferably 3% to 10% by mass.

The content of the compound represented by the general formula (NU-05) is preferably 0% to 30% by mass, more preferably 0% to 20% by mass, and still more preferably 0% to 10% by mass.

The content of the compound represented by the general formula (NU-06) is preferably 3% to 30% by mass, more preferably 3% to 20% by mass, and still more preferably 3% to 10% by mass.

The liquid crystal composition of the present invention may contain one or two or more polymerizable compounds.

The liquid crystal composition of the present invention may contain one or two or more polymerizable compounds represented by general formula (RM) as the polymerizable compounds.

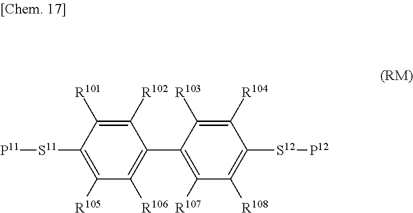

In the formula, R¹⁰¹, R¹⁰², R¹⁰³, R¹⁰⁴, R¹⁰⁵, R¹⁰⁶, R¹⁰⁷, and R¹⁰⁸ each independently represent P¹³—S¹³—, an alkyl group having 1 to 18 carbon atoms, which may be substituted by a fluorine atom, an alkoxy group having 1 to 18 carbon atoms, which may be substituted by a fluorine atom, a fluorine atom, or a hydrogen atom; P¹¹, P¹², and P¹³ each independently represent a group selected from formula (Re-1) to formula (Re-9)

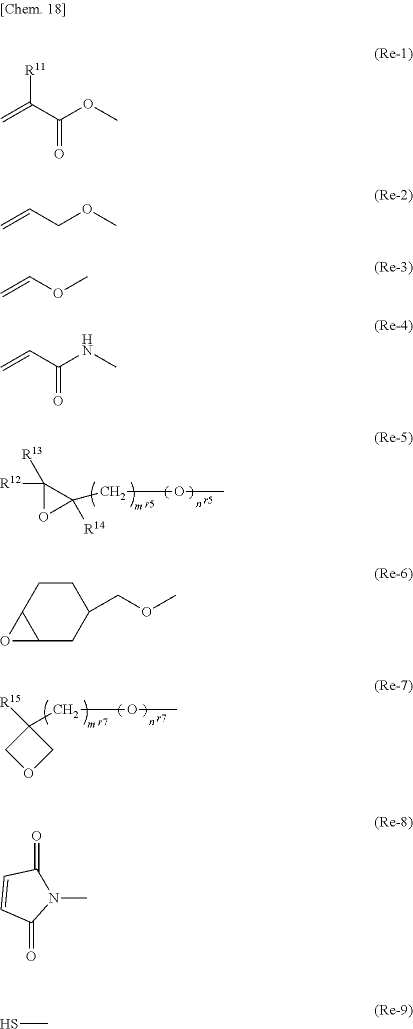

(in the formulae, R¹¹, R¹², R¹³, R¹⁴, and R¹⁵ each independently represent an alkyl group having 1 to 5 carbon atoms, a fluorine atom, or a hydrogen atom, and m^{r5}, m^{r7}, n^{r5}, and n^{r7} each independently represent 0, 1, or 2); S¹¹, S¹², and S¹² each independently represent a single bond or an alkylene group having 1 to 15 carbon atoms, in which one —CH₂— or two or more unadjacent —CH₂— in the alkylene group may be independently substituted by —O—, —OCO—, or —COO— so that oxygen atoms are not directly adjacent to each other; and when there are a plurality of P¹³ and S¹³ they may be the same or different.

The liquid crystal composition containing the polymerizable compound represented by the general formula (RM) is suitable for manufacturing a PSA-mode or PSVA-mode liquid crystal display device.

The liquid crystal composition containing the polymerizable compound represented by the general formula (RM) has a moderately high polymerization rate and thus can impart a desired pretilt angle with a short ultraviolet irradiation time. Further, the amount of the polymerizable compounds remaining can be decreased. Therefore, the production efficiency of the PSA-mode or PSVA-mode liquid crystal display device can be improved. Also, there is exhibited the effect of preventing or significantly decreasing the occurrence of a display defect (for example, a defect of image-sticking or the like) due to a change in pretilt angle. In the specification of the present invention, the display defect represents a display defect due to a change in pretilt angle with time, a display defect due to the amount of unreacted polymerizable compound remaining, and a display defect due to a decrease in voltage holding ratio.

In the general formula (RM), R¹⁰¹, R¹⁰², R¹⁰³, R¹⁰⁴, R¹⁰⁵, R¹⁰⁶, R¹⁰⁷, and R¹⁰⁸ each independently represent P¹³—S¹³—, an alkyl group having 1 to 18 carbon atoms, which may be substituted by a fluorine atom, an alkoxy group having 1 to 18 carbon atoms, which may be substituted by a fluorine atom, a fluorine atom, or a hydrogen atom. In the case of an alkyl group or alkoxy group, the number of carbon atoms is preferably 1 to 16, more preferably 1 to 10, still more preferably 1 to 8, still more preferably 1 to 6, and still more preferably 1 to 3. The alkyl group and alkoxy group may be linear or branched and are particularly preferably linear.

In the general formula (RM), R¹⁰¹, R¹⁰², R¹⁰³, R¹⁰⁴, R¹⁰⁵, R¹⁰⁶, R¹⁰⁷, and R¹⁰⁸ preferably each independently represent P¹³—S¹³—, an alkoxy group having 1 to 3 carbon atoms, which may be substituted by a fluorine atom, a fluorine atom, or a hydrogen atom, and more preferably each represent P¹³—S¹³—, an alkoxy group having 1 to 3 carbon atoms, a fluorine atom, or a hydrogen atom. The alkoxy group preferably has 1 or more and 3 or less carbon atoms, more preferably has 1 or more and 2 or less carbon atoms, and particularly preferably has 1 carbon atom.

In addition, P¹¹, P¹², and P¹³ may all be the same polymerizable group (formula (Re-1) to formula (Re-9)) or different polymerizable groups.

In the general formula (RM), P¹¹, P¹², and P¹³ are preferably each the formula (Re-1), the formula (Re-2), the formula (Re-3), the formula (Re-4), the formula (Re-5), or the formula (Re-7), more preferably each the formula (Re-1), the formula (Re-2), the formula (Re-3), or the formula (Re-4), still more preferably each the formula (Re-1), and particularly preferably each an acryl group or a methacryl group.

At least one of P¹¹ and P¹² is preferably the formula (Re-1), more preferably an acryl group or methacryl group, and still more preferably a methacryl group, and P¹¹ and P¹² are particularly preferably methacryl groups.

In the general formula (RM), S¹¹, S¹², and S¹³ are preferably each independently a single bond or an alkylene group having 1 to 5 carbon atoms and particularly preferably each independently a single bond. When S¹¹, S¹², and S¹³ are each a single bond, the amount of the polymerizable compound remaining after ultraviolet irradiation is sufficiently decreased, thereby causing little occurrence of a display defect due to a change in the pretilt angle.

The lower limit of the content of the polymerizable compound represented by the general formula (RM) in the liquid crystal composition of the present invention is preferably 0.01% by mass, preferably 0.02% by mass, preferably 0.03% by mass, preferably 0.04% by mass, preferably 0.05% by mass, preferably 0.06% by mass, preferably 0.07% by mass, preferably 0.08% by mass, preferably 0.09% by mass, preferably 0.1% by mass, preferably 0.12% by mass, preferably 0.15% by mass, preferably 0.17% by mass, preferably 0.2% by mass, preferably 0.22% by mass, preferably 0.25% by mass, preferably 0.27% by mass, preferably 0.3% by mass, preferably 0.32% by mass, preferably 0.35% by mass, preferably 0.37% by mass, preferably 0.4% by mass, preferably 0.42% by mass, preferably 0.45% by mass, preferably 0.5% by mass, or preferably 0.55% by mass. The upper limit of the content of the polymerizable compound represented by the general formula (RM) in the liquid crystal composition of the present invention is preferably 5% by mass, preferably 4.5% by mass, preferably 4% by mass, preferably 3.5% by mass, preferably 3% by mass, preferably 2.5% by mass, preferably 2% by mass, preferably 1.5% by mass, preferably 1% by mass, preferably 0.95% by mass, preferably 0.9% by mass, preferably 0.85% by mass, preferably 0.8% by mass, preferably 0.75% by mass, preferably 0.7% by mass, preferably 0.65% by mass, preferably 0.6% by mass, preferably 0.55% by mass, preferably 0.5% by mass, preferably 0.45% by mass, or preferably 0.4% by mass.

In a description in further detail, in order to achieve the satisfactory pretilt angle, the small amount of polymerizable compound remaining, or the high voltage holding ratio (VHR), the content thereof is preferably 0.2% to 0.6% by mass. When it is considered important to suppress precipitation at a low temperature, the content is preferably 0.01% to 0.4% by mass. In order to achieve the particularly high response speed, it is also preferred to increase the content to 2% by mass.

In addition, when the liquid crystal composition contains a plurality of polymerizable compounds represented by the general formula (RM), the content is preferably 0.01% to 0.4% by mass. Therefore, in order to solve all problems, the content of the polymerizable compound represented by the general formula (RM) is preferably adjusted within a range of 0.1% to 0.6% by mass.

Preferred examples of the polymerizable compound represented by the general formula (RM) according to the present invention include compounds represented by general formulae (RM-1) to (RM-10). A PSA-mode liquid crystal display device using any one of these compounds exhibits a small amount of polymerizable compound remaining and has a satisfactory pretilt angle and no or very few defects such as alignment defect and display defect due to a change in the pretilt angle or the like.

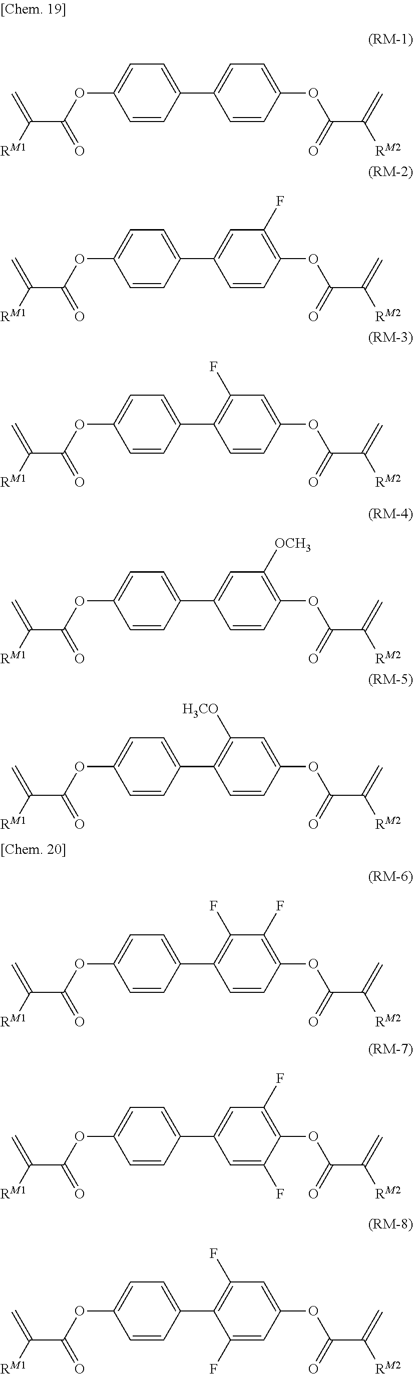

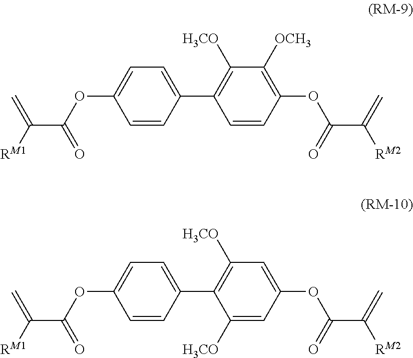

In the formulae, R^{M1} and R^{M2} each independently represent an alkyl group having 1 to 5 carbon atoms, a fluorine atom, or a hydrogen atom, but more preferably represent an alkyl group having 1 carbon atom or a hydrogen atom.

The liquid crystal composition according to the present invention can contain one or two or more compounds having a terphenyl structure or a tetraphenyl structure and a dielectric anisotropy Δε more than +2. The Δε of a compound is a value extrapolated from the measured value of the dielectric anisotropy of a composition prepared by adding the compound to a composition substantially dielectrically neutral at 25° C. The compounds are used in combination according to the desired performances such as, for example, low-temperature solubility, transition temperature, electric reliability, refractive index anisotropy, etc. In particular, the reactivity of the polymerizable compound in the liquid crystal composition containing the polymerizable compound can be increased.

The lower limit value of the preferred content of the compound having a terphenyl structure or a tetraphenyl structure and a dielectric anisotropy Δε more than +2 relative to the total amount of the liquid crystal composition of the present invention is 0.1%, 0.5%, 1%, 1.5%, 2%, 2.5%, 3%, 4%, 5%, or 10%. For example, in an aspect of the present invention, the upper limit value of the preferred content relative to the total amount of the liquid crystal composition of the present invention is 20%, 15%, 10%, 9%, 8%, 7%, 6%, 5%, 4%, or 3%.

In the case of producing the liquid crystal composition of the present invention which keeps the viscosity low and has a high response speed, the lower limit value is preferably rather low, and the upper limit value is preferably rather low. Further, in the case of producing the liquid crystal composition causing little image-sticking, the lower limit value is preferably rather low, and the upper limit value is preferably rather low. Further, in the case of increasing the dielectric anisotropy for keeping the drive voltage low, the lower limit value is preferably rather high, and the upper limit value is preferably rather high. In the case of increasing the reactivity of the polymerizable compound contained in the liquid crystal composition, the lower limit value is preferably rather low, and the upper limit value is preferably rather low.

Preferred examples of the compound which can be used in the liquid crystal composition of the present invention and which has a terphenyl structure or a tetraphenyl structure and a dielectric anisotropy Δε more than +2 include compounds represented by general formulae (M-8.51) to (M-8.54). Among these, it is preferred to contain a compound represented by the formula (M-8.52).

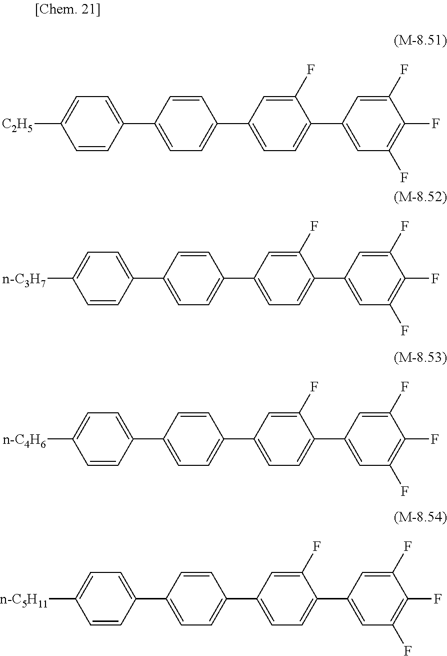

Examples of the compound which can be used in the liquid crystal composition of the present invention and which has a terphenyl structure or a tetraphenyl structure and a dielectric anisotropy Δε more than +2 include compounds selected from a group represented by general formula (M-7).

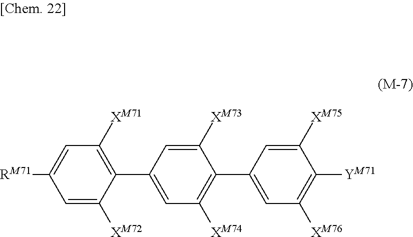

(In the formula, X^{M71} to X^{M76} each independently represent a fluorine atom or a hydrogen atom, R^{M71} represents an alkyl group having 1 to 5 carbon atoms, an alkenyl group having 2 to 5 carbon atoms, or an alkoxy group having 1 to 4 carbon atoms, and Y^{M71} represents a fluorine atom or OCF₃.)

The types of compounds which can be combined are not particularly limited, but it is preferred to contain one or two of these compounds, it is more preferred to contain one to three of these compounds, and it is particularly preferred to contain one to four of these compounds.

The content of a compound represented by the general formula (M-7) has an upper limit value and a lower limit value according to each embodiment in view of the characteristics such as low-temperature solubility, transition temperature, electric reliability, birefringence, etc.

The lower limit value of the preferred content of the compound represented by the general formula (M-7) relative to the total amount of the liquid crystal composition of the present invention is 1%, 2%, 4%, 5%, 8%, 10%, 13%, 15%, 18%, or 20%. The upper limit value of the preferred content is 30%, 28%, 25%, 23%, 20%, 18%, 15%, 13%, 10%, 8%, or 5%.

Further examples of the compound represented by the general formula (M-7) include compounds represented by formula (M-7.1) to formula (M-7.4), and a compound represented by formula (M-7.2) is preferred.

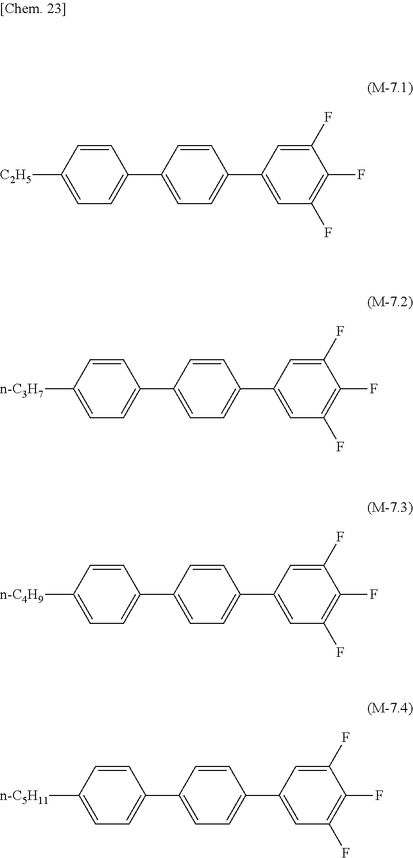

Further examples of the compound represented by the general formula (M-7) include compounds represented by formula (M-7.11) to formula (M-7.14), and compounds represented by the formula (M-7.11) and formula (M-7.12) are preferred.

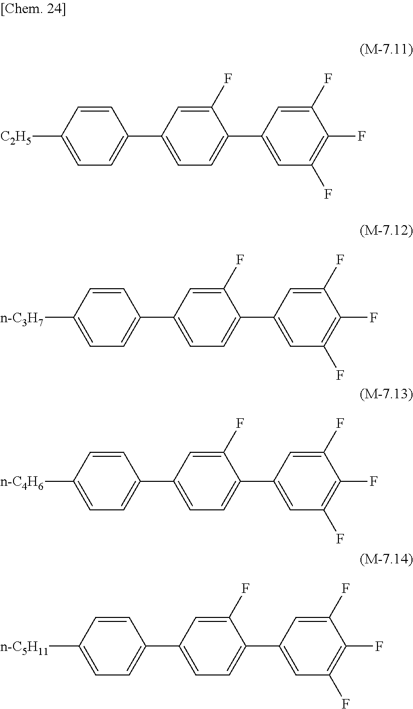

Further examples of the compound represented by the general formula (M-7) include compounds represented by formula (M-7.21) to formula (M-7.24), and compounds represented by the formula (M-7.21) and formula (M-7.22) are preferred.

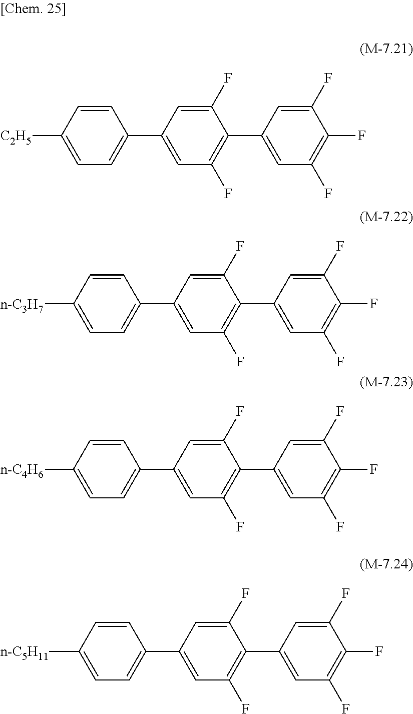

In order to increase Tₙᵢ of the liquid crystal composition of the present invention, the liquid crystal composition may contain any one of compounds of formula (L-7.1) to formula (L-7.4), formula (L-7.11) to formula (L-7.13), formula (L-7.21) to formula (L-7.23), formula (L-7.31) to formula (L-7.34), formula (L-7.41) to formula (L-7.44), and formula (L-7.51) to formula (L-7.53), which have four rings and substantially zero dielectric value (generally within a range of −2 to +2).

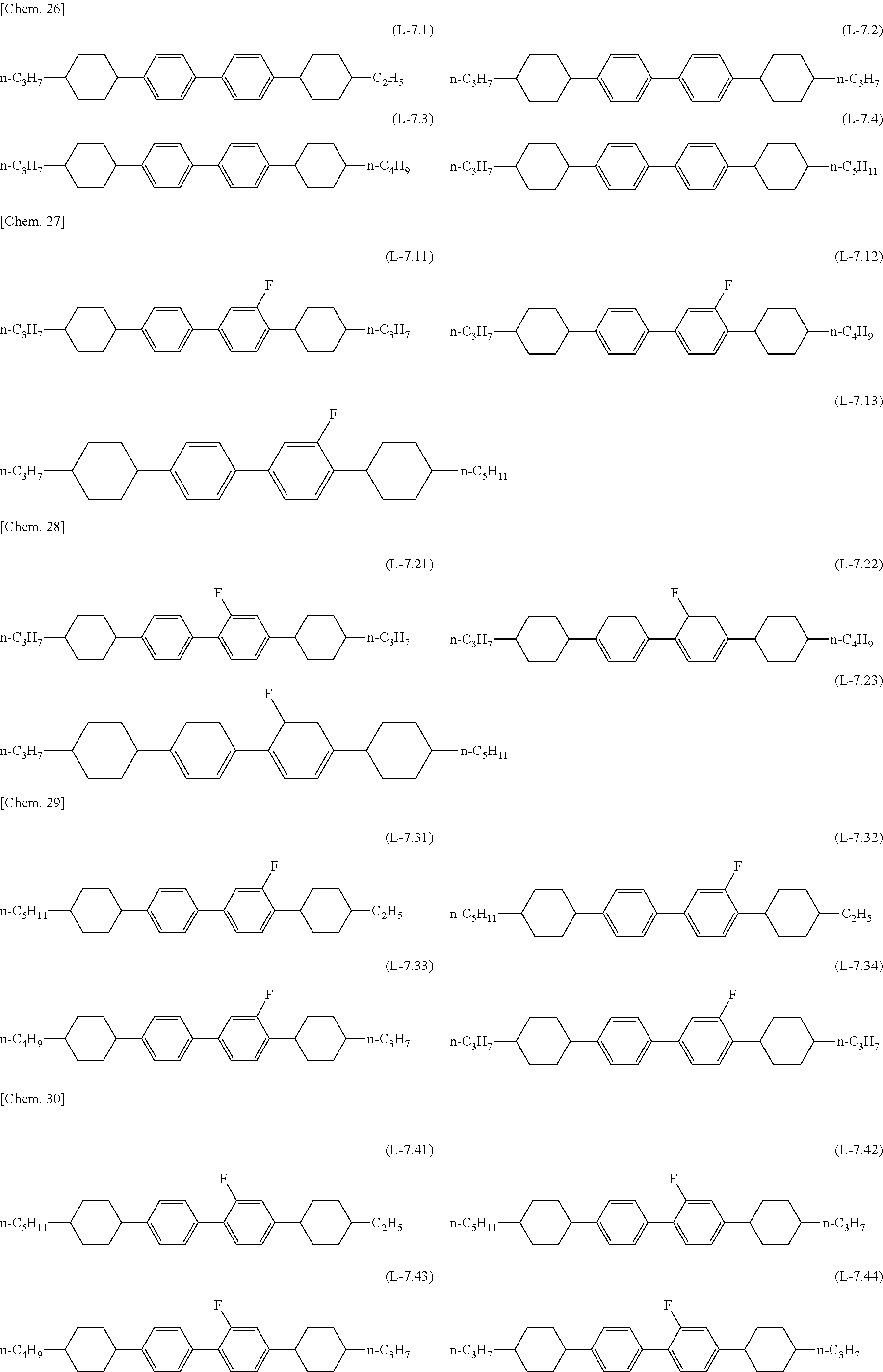

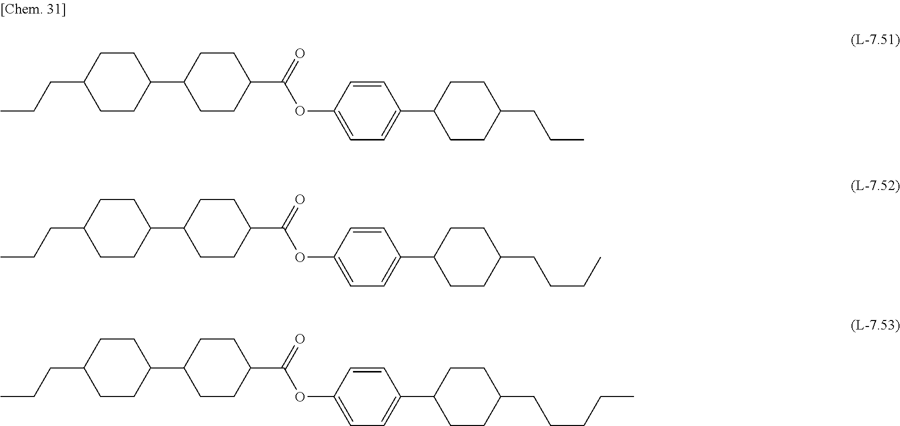

Besides the compounds described above, the liquid crystal composition of the present invention may contain a general nematic liquid crystal, smectic liquid crystal, cholesteric liquid crystal, antioxidant, ultraviolet absorber, light stabilizer, infrared absorber, or the like.

Examples of the antioxidant include hindered phenols represented by general formula (H-1) to general formula (H-4).

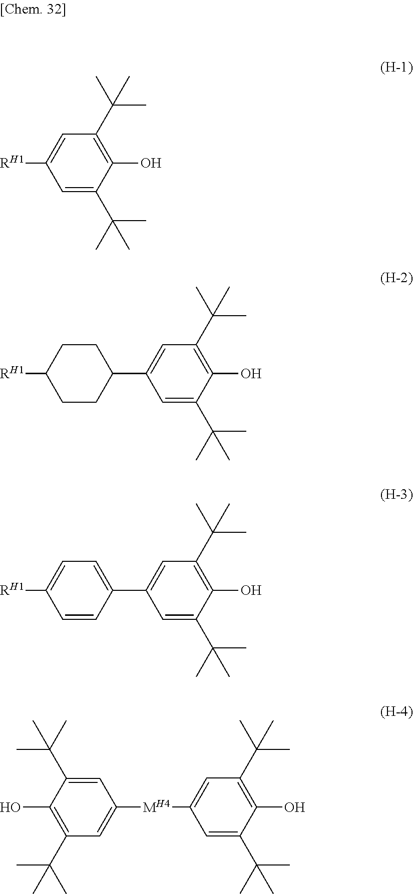

In the general formula (H-1) to the general formula (H-3), Rⁿ each independently represent an alkyl group having 1 to 10 carbon atoms, an alkoxy group having 1 to 10 carbon atoms, an alkenyl group having 2 to 10 carbon atoms, or an alkenyloxy group having 2 to 10 carbon atoms, wherein one —CH₂— or two or more unadjacent —CH₂— present in the group may be each independently substituted by —o— or —S—, and one or two or more hydrogen atoms present in the group may be each independently substituted by a fluorine atom or a chlorine atom. More specifically, R^{H1} is preferably an alkyl group having 2 to 7 carbon atoms, an alkoxy group having 2 to 7 carbon atoms, an alkenyl group having 2 to 7 carbon atoms, or an alkenyloxy group having 2 to 7 carbon atoms, and more preferably an alkyl group having 3 to 7 carbon atoms or an alkenyl group having 2 to 7 carbon atoms.

In the general formula (H-4), M^{H4} represents an alkylene group having 1 to 15 carbon atoms (wherein one or two or more —CH₂— in the alkylene group may be substituted by —O—, —CO—, —COO—, or —OCO— so that oxygen atoms are not directly adjacent to each other) , —OCH₂—, —CH₂O—, —COO—, —COO—, —CF₂O—, —OCF₂—, —CF₂CF₂—, —CH═CH—COO—, —CH═CH-OCO—, —COO—CH═CH—, —OCO—CH═CH—, —CH═CH—, —C≡C—, a single bond, a 1,4-phenylene group (any desired hydrogen atom in the 1,4-phenylene group may be substituted by a fluorine atom), or a trans-1,4-cyclohexylene group, but is preferably an alkylene group having 1 to 14 carbon atoms. In view of volatility, the number of carbon atoms is preferably as large as possible, but in view of viscosity, the number of carbon atoms is preferably not too large. Therefore, the number of carbon atoms is more preferably 2 to 12, more preferably 3 to 10, more preferably 4 to 10, more preferably 5 to 10, or more preferably 6 to 10.

In the general formula (H-1) to the general formula (H-4), one or two or more unadjacent —CH═ in the 1,4-phenylene group may be substituted by —N═. Also, hydrogen atoms in the 1,4-phenylene group may be each independently substituted by a fluorine atom or a chlorine atom.

In the general formula (H-2) and the general formula (H-4), one or two or more unadjacent —CH₂— in the 1,4-cyclohexylene group may be substituted by —O— or —S—. Also, hydrogen atoms in the 1,4-cyclohexylene group may be each independently substituted by a fluorine atom or a chlorine atom.

Specific examples thereof include formula (H-11) to formula (H-15).

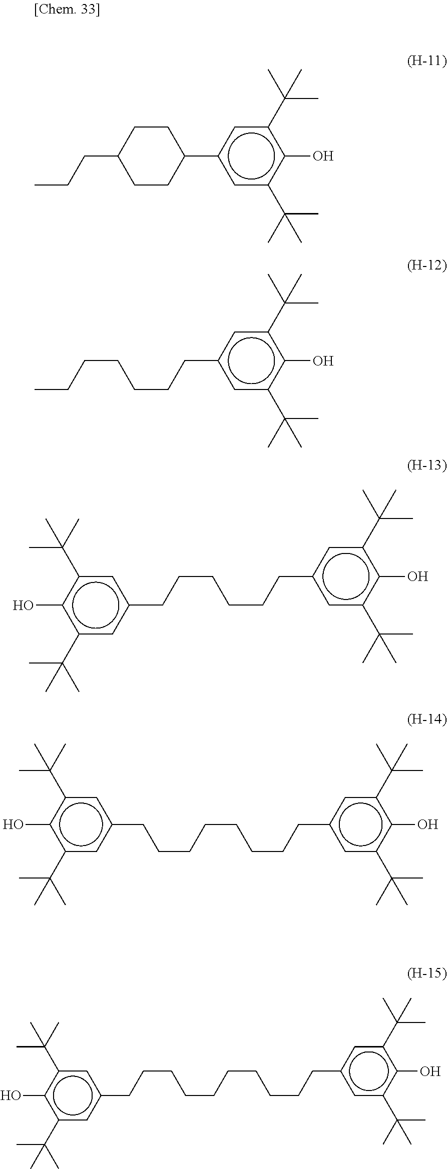

When the liquid crystal composition of the present invention contains the antioxidant, the content is preferably 10 ppm by mass or more, preferably 20 ppm by mass or more, or preferably 50 ppm by mass or more. The upper limit of the content of the antioxidant is 10000 ppm by mass, but is preferably 1000 ppm by mass, preferably 500 ppm by mass, or 100 ppm by mass.

The nematic phase-isotropic liquid phase transition temperature (Tₙᵢ) of the liquid crystal composition of the present invention is 60° C. to 120° C., preferably 70° C. to 100° C., and particularly preferably 70° C. to 85° C.

According to a preferred embodiment of the present invention, estimated cases of the liquid crystal composition include the case where the whole of the liquid crystal composition shows positive dielectric anisotropy and the case where the whole of the liquid crystal composition shows negative dielectric anisotropy, but preferred is the case where the whole of the liquid crystal composition shows negative dielectric anisotropy.

The refractive index anisotropy (Δn) at 20° C. of the liquid crystal composition of the present invention is 0.08 to 0.14, more preferably 0.09 to 0.13, and particularly preferably 0.09 to 0.12. In further detail, in a case corresponding to a thin cell gap, the refractive index anisotropy is preferably 0.10 to 0.13, while in a case corresponding to a thick cell gap, the refractive index anisotropy is preferably 0.08 to 0.10.

The rotational viscosity (γ₁) at 20° C. of the liquid crystal composition of the present invention is 50 to 160 mPa·s, preferably 55 to 160 mPa·s, preferably 60 to 160 mPa·s, preferably 80 to 150 mPa·s, preferably 90 to 140 mPa·s, preferably 90 to 130 mPa·s, or preferably 100 to 130 mPa·s.

The dielectric anisotropy (Δε) at 20° C. of the liquid crystal composition of the present invention is −2.0 to −8.0, preferably −2.0 to −6.0, more preferably −2.0 to −5.0, still more preferably −2.5 to −4.0, and particularly preferably −2.5 to −3.5.

Among the compounds constituting the liquid crystal composition of the present invention, the upper limit value of the total content of compounds having an alkenyl group is preferably 10%, preferably 8%, preferably 6%, preferably 5%, preferably 4%, preferably 3%, preferably 2%, preferably 1%, or preferably 0%. The range of the total content of compounds having an alkenyl group is preferably 0% to 10%, preferably 0% to 8%, preferably 0% to 5%, preferably 0% to 4%, preferably 0% to 3%, or preferably 0% to 2%.

The liquid crystal composition of the present invention preferably contains the compounds of the formula (B31) and the formula (CB31) as essential components, further contains one or two or more compounds selected from the compound group represented by the general formula (N-01), the general formula (N-02), the general formula (N-03), the general formula (N-04), the general formula (N-05), and the general formula (N-06), and further contains one or two or more compounds selected from the compound group represented by the general formulae (NU-01) to (NU-06). The liquid crystal composition of the present invention more preferably contains the compounds of the formula (B31) and the formula (CB31) as essential components, further contains one or two or more compounds selected from the compound group represented by the general formula (N-01), the general formula (N-02), the general formula (N-03), and the general formula (N-04), and further contains one or two or more compounds selected from the compound group represented by the general formulae (NU-01) to (NU-06). The liquid crystal composition of the present invention still more preferably contains the compounds of the formula (B31) and the formula (CB31) as essential components, further contains one or two or more compounds selected from the compound group represented by the general formula (N-01), the general formula (N-02), the general formula (N-03), and the general formula (N-04), and further contains one or two or more compounds represented by the general formula (NU-01).

When the liquid crystal composition of the present invention contains the compounds of the formula (B31) and the formula (CB31) as essential components, further contains one or two or more compounds selected from the compound group represented by the general formula (N-01), the general formula (N-02), the general formula (N-03), the general formula (N-04), the general formula (N-05), and the general formula (N-06), and further contains one or two or more compounds selected from the compound group represented by the general formulae (NU-01) to (NU-06), the upper limit value of the total content of the constituent components is preferably 100% by mass, 99% by mass, 98% by mass, 97% by mass, 96% by mass, 95% by mass, 94% by mass, 93% by mass, 92% by mass, 91% by mass, 90% by mass, 89% by mass, 88% by mass, 87% by mass, 86% by mass, 85% by mass, or 84% by mass. The lower limit value of the total content of the constituent components is preferably 78% by mass, 80% by mass, 81% by mass, 83% by mass, 85% by mass, 86% by mass, 87% by mass, 88% by mass, 89% by mass, 90% by mass, 91% by mass, 92% by mass, 93% by mass, 94% by mass, 95% by mass, 96% by mass, 97% by mass, 98% by mass, or 99% by mass.

When the liquid crystal composition of the present invention contains the compounds of the formula (B31) and the formula (CB31) as essential components, further contains one or two or more compounds selected from the compound group represented by the general formula (N-01), the general formula (N-02), the general formula (N-03), and the general formula (N-04), and further contains one or two or more compounds selected from the compound group represented by the general formulae (NU-01) to (NU-06), the upper limit value of the total content of the constituent components is more preferably 100% by mass, 99% by mass, 98% by mass, 97% by mass, 96% by mass, 95% by mass, 94% by mass, 93% by mass, 92% by mass, 91% by mass, 90% by mass, 89% by mass, 88% by mass, 87% by mass, 86% by mass, 85% by mass, or 84% by mass. The lower limit value of the total content of the constituent components is more preferably 78% by mass, 80% by mass, 81% by mass, 83% by mass, 85% by mass, 86% by mass, 87% by mass, 88% by mass, 89% by mass, 90% by mass, 91% by mass, 92% by mass, 93% by mass, 94% by mass, 95% by mass, 96% by mass, 97% by mass, 98% by mass, or 99% by mass.

When the liquid crystal composition of the present invention containing the polymerizable compound contains the compounds of the formula (B31) and the formula (CB31) as essential components, further contains one or two or more compounds selected from the compound group represented by the general formula (N-01), the general formula (N-02), the general formula (N-03), the general formula (N-04), the general formula (N-05), and the general formula (N-06), further contains one or two or more compounds selected from the compound group represented by the general formulae (NU-01) to (NU-06), and further contains one or two or more compounds represented by the general formula (RM), the upper limit value of the total content of the constituent components is preferably 100% by mass, 99% by mass, 98% by mass, 97% by mass, 96% by mass, 95% by mass, 94% by mass, 93% by mass, 92% by mass, 91% by mass, 90% by mass, 89% by mass, 88% by mass, 87% by mass, 86% by mass, 85% by mass, or 84% by mass. The lower limit value of the total content of the constituent components is preferably 78% by mass, 80% by mass, 81% by mass, 83% by mass, 85% by mass, 86% by mass, 87% by mass, 88% by mass, 89% by mass, 90% by mass, 91% by mass, 92% by mass, 93% by mass, 94% by mass, 95% by mass, 96% by mass, 97% by mass, 98% by mass, or 99% by mass.

The liquid crystal display device using the liquid crystal composition of the present invention has the remarkable characteristic of fast response and exhibits a satisfactory tilt angle, no or a negligible small amount of unreacted polymerizable compound, and a high voltage holding ratio (VHR). Thus, defects such as alignment defect and display defect are eliminated or sufficiently suppressed. In addition, the tilt angle and the amount of polymerizable compound remaining can be easily controlled, and thus the energy cost for manufacturing can be easily optimized and decreased, thereby optimizing improvement in production efficiency and stable mass-production.

The liquid crystal display device using the liquid crystal composition of the present invention is useful particularly for a liquid crystal display device for active matrix driving, and can be used for a liquid crystal display for a PSA mode, a PSVA mode, a VA mode, a PS-IPS ode, or a PS-FFS mode.

The liquid crystal display device according to the present invention preferably includes a first substrate and a second substrate which are disposed opposite to each other, a common electrode provided on the first substrate or the second substrate, a pixel electrode provided on the first substrate or the second substrate and having a thin-film transistor, and a liquid crystal layer which contains a liquid crystal composition and which is provided between the first substrate and the second substrate. If required, an alignment film which controls the alignment direction of liquid crystal molecules may be provided on the facing surface side of at least one of the first substrate and/or the second substrate so as to be in contact with the liquid crystal layer. The alignment film can be properly selected from a vertical alignment film and a horizontal alignment film in accordance with the drive mode of the liquid crystal display device, and a known alignment film such as a rubbing alignment film (for example, polyimide), an optical alignment film (decomposable polyimide or the like), or the like can be used. Further, a color filter may be properly provided on the first substrate or the second substrate, and a color filter can be provided on the pixel electrode or the common electrode.

A transparent material with flexibility, such as glass or plastic, can be used for two substrates of a liquid crystal cell used in the liquid crystal display device according to the present invention, and one of the substrates may be made of an opaque material such as silicon or the like. A transparent substrate having a transparent electrode layer can be produced by, for example, sputtering indium tin oxide (ITO) on the transparent substrate such as a glass plate or the like.

The color filter can be formed by, for example, a pigment dispersion method, a printing method, an electrodeposition method, a dyeing method, or the like. An example of a method for forming the color filter by the pigment dispersion method is described. A curable color composition for a color filter is applied on the transparent substrate, patterned, and then cured by heating or light irradiation. These steps are performed for each of the three colors of red, green, and blue, whereby pixel portions for the color filter can be formed. In addition, a pixel electrode provided with an active element such as TFT, a thin-film diode, a metal-insulator-metal resistivity element, or the like may be provided on the substrate.

The first substrate and the second substrate are preferably opposed to each other so that the common electrode and the pixel element layer are disposed on the inside.

The gap between the first substrate and the second substrate may be adjusted through a spacer. In this case, the gap is preferably adjusted so that the thickness of the resultant light control layer is 1 to 100 μm. The thickness is more preferably 1.5 to 10 μm, and when a polarizing plate is used, the product of the refractive index anisotropy Δn of liquid crystal and the cell thickness d is preferably adjusted to maximize the contrast. Also, when two polarizing plates are present, the polarization axis of each of the polarizing plates can be adjusted to improve the viewing angle and contrast. Further, a retardation film can be used for widening the viewing angle. Examples of the spacer include glass particles, plastic particles, alumina particles, a photoresist material, and the like. Then, a seal agent such as an epoxy-based thermosetting composition or the like is screen-printed on each of the substrates provided with a liquid crystal injection port, the substrates are bonded together, and then the seal agent is thermally cured by heating.

A method for holding the liquid crystal composition between the two substrates can use a general vacuum injection method or ODF method, or the like.

In order to form an alignment state in the liquid crystal display device of the present invention, a liquid crystal composition containing a polymerizable compound is used, and the alignment state can be formed by polymerizing the polymerizable compound in the liquid crystal composition.

In order to achieve the good alignment performance of liquid crystal, polymerization at a proper polymerization rate is desired. Therefore, a method of polymerizing the polymerizable compound in the liquid crystal composition of the present invention is preferably a method of polymerization by irradiation with one or combination of two or more of ultraviolet light and active energy rays such as electron beams and the like or by sequential irradiation with these rays. When ultraviolet light is used, a polarized light source or an unpolarized light source may be used. When the liquid crystal composition is polymerized in the state of being held between the two substrates, at least the irradiation-side substrate is required to be imparted with proper transparency to active energy rays. Another method may also be used, in which only a specified portion is polymerized using a mask during light irradiation, and then the alignment state of an unpolymerized portion is changed by changing the condition such as an electric field, a magnetic field, or a temperature, or the like, followed by further polymerization by irradiation with active energy rays. In particular, in the case of ultraviolet exposure, the ultraviolet exposure is preferably performed with the alternating-current electric field applied to the liquid crystal composition. The alternating-current electric field applied is preferably of alternating current at a frequency of 10 Hz to 10 kHz and more preferably a frequency of 60 Hz to 10 kHz, and the voltage is selected depending on the desired pretilt angle of the liquid crystal display device. That is, the pretilt angle of the liquid crystal display device can be controlled by the voltage applied. In a PSVA-mode liquid crystal display device, the pretilt angle is preferably controlled to 80° to 89.9° from the viewpoint of alignment stability and contrast.

When the polymerizable compound contained in the liquid crystal composition of the present invention is polymerized by irradiation with ultraviolet light or active energy rays, such as electron beams or the like, the temperature is not particularly limited. For example, when the liquid crystal composition of the present invention is applied to a liquid crystal display device provided with a substrate having an alignment film, the temperature is preferably within a range in which the liquid crystal state of the liquid crystal composition is maintained. Polymerization is preferably performed at a temperature close to room temperature or typically at 15° C. to 35° C.

On the other hand, for example, when the liquid crystal composition of the present invention is applied to a liquid crystal display device provided with a substrate without an alignment film, the temperature range of irradiation may be wider than that applied to the liquid crystal display device provided with a substrate having an alignment film.

Usable examples of a lamp which generates ultraviolet light include a metal halide lamp, a high-pressure mercury lamp, an ultra-high-pressure mercury lamp, and the like. The irradiating ultraviolet light is preferably ultraviolet light at a wavelength within a wavelength region which is not the absorption wavelength region of the liquid crystal composition. If required, ultraviolet light is preferably cut and used. The intensity of the irradiating ultraviolet light is preferably 0.1 mW/cm² to 100 W/cm² and more preferably 2 mW/cm² to 50 W/cm². The energy amount of the irradiating ultraviolet light can be properly adjusted, but is preferably 10 mJ/cm² to 500 J/cm² and more preferably 100 mJ/cm² to 200 J/cm². The intensity may be changed during ultraviolet irradiation. The time of ultraviolet irradiation is properly selected according to the intensity of irradiating ultraviolet light, but is preferably 10 seconds to 3600 seconds and more preferably 10 seconds to 600 seconds.

### EXAMPLES

The present invention is described in further detail below by giving examples, but the present invention is not limited to these examples. In a composition of each of examples and comparative examples, “%” represents “% by mass”. In the examples, compounds are described by using the following abbreviations.

(Side Chain)

-n —CₙH₂ₙ₊₁, a linear alkyl group having n carbon atoms

n-CₙH₂ₙ₊₁—, a linear alkyl group having n carbon atoms

-On-OCₙH₂ₙ₊₁, a linear alkoxy group having n carbon atoms

nO—CₙH₂ₙ₊₁O—, a linear alkoxy group having n carbon atoms

—V—CH═CH₂

V—CH₂═CH—

—V—CH═CH—

—O1V—O—CH₂—CH═CH₂

—V1-CH═CH—CH₃

1V—CH₂—CH═CH—

-2V—CH₂—CH₂—CH═CH₂

V2-CH₂═CH—CH₂—CH₂—

-2V1-CH₂—CH₂—CH═CH—CH₃

1V2-CH₃—CH═CH—CH₂—CH₂—

—F—F

—OCF3-OCF₃

(Linking Group)

—CF2O—CF₂—O—

—OCF2-O—CF₂—

-1O—CH₂—O—

—O1-O—CH₂—

-2-CH₂—CH₂—

—COO—COO—

—OCO—OCO—

(Ring Structure)

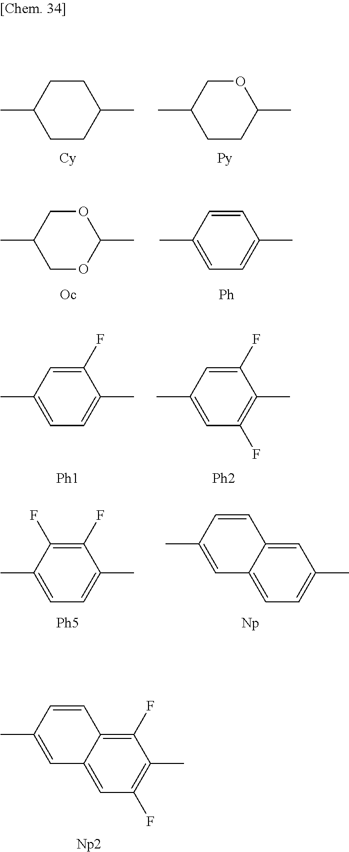

In the examples, the measured characteristics are as follows.

Tₙᵢ: nematic phase-isotopic liquid phase transition temperature (° C.)

Δn: refractive index anisotropy at 20° C.

γ₁: rotational viscosity at 20° C. (mPa·s)

Δε: dielectric anisotropy at 20° C.

K₃₃: elastic constant K₃₃ at 20° C. (pN)

VHR (UV): voltage holding ratio (%) after ultraviolet irradiation (irradiation conditions 1 and 2)

(Method for Producing Liquid Crystal Display Device and Evaluation Method)

First, a liquid crystal composition containing a polymerizable compound was injected by a vacuum injection method into a liquid crystal cell having a cell gap of 3.3 μm and including a substrate with ITO which was formed by applying a polyimide alignment film for inducing vertical alignment and then by rubbing the polyimide alignment film. In this case, JALS 2096 manufactured by JSR corporation was used as a material for forming the vertical alignment film.

Then, the liquid crystal cell in which the liquid crystal composition containing the polymerizable compound had been injected was irradiated with ultraviolet light by using a high-pressure mercury lamp with a voltage of 20V applied at a frequency of 100 Hz through a filter which cut ultraviolet light at 325 nm or less. In this case, the ultraviolet light was adjusted so that the illuminance measured under the condition of a center wavelength of 365 nm was 100 mW/cm² and was irradiated for 2 minutes. These ultraviolet irradiation conditions were referred to as “irradiation conditions 1”. Under the irradiation conditions 1, liquid crystal molecules in the liquid crystal cell were imparted with a pretilt angle.

Next, a fluorescent UV lamp was used and adjusted so that the illuminance measured under the condition of a center wavelength of 313 nm was 3 mW/cm², and ultraviolet light was further irradiated for 90 minutes, thereby producing a liquid crystal display device. These ultraviolet irradiation conditions were referred to as “irradiation conditions 2”. Under the irradiation conditions 2, the amount of unreacted polymerizable compound remaining in the liquid crystal cell under the irradiation conditions 1 was decreased.

After the ultraviolet irradiation, a display defect (image-sticking) due to a change in pretilt angle was evaluated. First, the pretilt angle of the liquid crystal display device was measured as the pretilt angle (initial). A voltage of 30 V at a frequency of 100 Hz was applied to the liquid crystal display device for 24 hours. Then, the pretilt angle of the liquid crystal display device was measured as the pretilt angle (after test). A value obtained by subtracting the measured pretilt angle (after test) from the measured pretilt angle (initial) was regarded as a pretilt angle change amount (=absolute value of change in pretilt angle) [°]. The pretilt angle was measured by using OPTIPRO manufactured by Syntek Co., Ltd.

With a pretilt angle change amount closer to 0 [°] the possibility of occurrence of a display defect due to a change in pretilt angle is decreased, while with a pretilt angle change amount of 0.5 [°] or more, the possibility of occurrence of a display defect due to a change in pretilt angle is increased.

The amount [ppm] of polymerizable compound remaining in the liquid crystal display device after ultraviolet irradiation under the irradiation conditions 1 and irradiation conditions 2 was measured. A method for measuring the amount of polymerizable compound remaining is described. First, the liquid crystal display device was disassembled, the liquid crystal composition was taken out, and an acetonitrile solution thereof was prepared. Then, the peak area of each of the components was measured by using high-performance liquid chromatography. The amount of the polymerizable compound was determined from the ratio between the peak area of a liquid crystal compound used as an index and the peak area of the polymerizable compound. The amount of the polymerizable compound remaining was determined from the obtained value and the initial amount of the polymerizable compound added. The detection limit of the amount of polymerizable compound remaining was 100 ppm.

(Preparation of Liquid Crystal Composition and Evaluation Results)

Liquid crystal compositions of Example 1 (LC-1), Comparative Example (LC-A), Comparative Example 2 (LC-B), and Comparative Example 3 (LC-C) were prepared, and the physical property values thereof were measured. The configurations of the liquid crystal compositions and the results of physical property values are as shown in Table 1.

TABLE 1

| | | Compar- | Compar- | Compar- |
|---|---|---|---|---|
| | | ative | ative | ative |
| | Example 1 | Example 1 | Example 2 | Example 3 |
| | LC-1 | LC-A | LC-B | LC-C |
| 3-Cy-Cy-2 | 18 | 18 | 18 | 18 |
| 3-Cy-Cy-4 | 8 | 8 | 8 | 8 |
| 3-Cy-Ph—O2 | 4 | 4 | 4 | 4 |
| 3-Ph—Ph-1 | 11 | 11 | | |
| 5-Ph—Ph-1 | | | 11 | 11 |
| 3-Cy-Ph—Ph-1 | 10 | | 10 | |
| 3-Cy-Ph—Ph-2 | | 10 | | 10 |
| 3-Cy-1O—Ph5—O1 | 4 | 4 | 4 | 4 |
| 3-Cy-1O—Ph5—O2 | 7 | 7 | 7 | 7 |
| 2-Cy-Cy-1O—Ph5—O2 | 9 | 9 | 9 | 9 |
| 3-Cy-Cy-1O—Ph5—O2 | 9 | 9 | 9 | 9 |
| 2-Cy-Ph—Ph5—O2 | 5 | 5 | 5 | 5 |
| 3-Cy-Ph—Ph5—O2 | 5 | 5 | 5 | 5 |
| 3-Cy-Ph—Ph5—O3 | 5 | 5 | 5 | 5 |
| 3-Cy-Ph—Ph5—O4 | 5 | 5 | 5 | 5 |
| Total [%] | 100 | 100 | 100 | 100 |
| Tₙᵢ | 78.5 | 76.9 | 79.8 | 77.9 |
| Δn | 0.112 | 0.110 | 0.111 | 0.109 |
| Δε | −3.1 | −3.1 | −3.1 | −3.1 |
| γ₁ | 125 | 121 | 131 | 128 |
| K₃₃ | 14.8 | 13.5 | 14.5 | 13.8 |
| γ₁/K₃₃ | 8.4 | 9.0 | 9.0 | 9.3 |

It was confirmed that Example 1 (LC-1) has high Tₙᵢ, large Δn, negative Δε, small γ₁, large K₃₃, and small γ₁/K₃₃, and that a VA-mode liquid crystal display device produced by using the liquid crystal composition of this example exhibits sufficiently high response speed and a VHR(UV) value of as very high as 93%. In contrast, it was confirmed that Comparative Example 1 (LC-A), Comparative Example 2 (LC-B), and Comparative Example 3 (LC—C) have large γ₁/K₃₃ and that the response speed is significantly lower than that of Example 1 (LC-1) and thus the problem of the present invention cannot be solved.

A polymerizable compound-containing liquid crystal composition was prepared by adding 0.3% by mass of a polymerizable compound represented by the formula (RM-1) (in the formula, R^{M1} and R^{M2} each represent a methyl group) to 99.7% by mass of the liquid crystal composition of Example 1 (LC-1), and a PSA-mode liquid crystal display device was formed. As a result, it was confirmed that no display defect such as alignment unevenness occurs, and fast response is exhibited. It was also confirmed that the amount of polymerizable compound remaining in the PSA-mode liquid crystal display device is equal to or lower than the detection limit. In addition, an amount of change in pretilt angle was confirmed to be substantially zero [°]. Further, VHR(UV) was a value of as high as 94%.

A polymerizable compound-containing liquid crystal composition was prepared by adding 0.3% by mass of a polymerizable compound represented by the formula (RM-2) (in the formula, R^{M1} and R^{M2} each represent a methyl group) to 99.7% by mass of the liquid crystal composition of Example 1 (LC-1), and a PSA-mode liquid crystal display device was formed. As a result, it was confirmed that no display defect such as alignment unevenness occurs, and fast response is exhibited. It was also confirmed that the amount of polymerizable compound remaining in the PSA-mode liquid crystal display device is equal to or lower than the detection limit. In addition, an amount of change in pretilt angle was confirmed to be substantially zero [°]. Further, VHR(UV) was a value of as high as 96%.

A polymerizable compound-containing liquid crystal composition was prepared by adding 0.3% by mass of a polymerizable compound represented by the formula (RM-4) (in the formula, R^{M1} and R^{M2} each represent a methyl group) to 99.7% by mass of the liquid crystal composition of Example 1 (LC-1), and a PSA-mode liquid crystal display device was formed. As a result, it was confirmed that no display defect such as alignment unevenness occurs, and fast response is exhibited. It was also confirmed that the amount of polymerizable compound remaining in the PSA-mode liquid crystal display device is equal to or lower than the detection limit. In addition, an amount of change in pretilt angle was confirmed to be substantially zero [°]. Further, VHR(UV) was a value of as high as 95%.

The PSA-mode liquid crystal display device was subjected to ultraviolet irradiation under the irradiation conditions 1 and further ultraviolet irradiation under the irradiation conditions 2. The measurement conditions of the response speed included a Von of 6 V, a Voff of 1 V, and a measurement temperature of 25° C., and DMS 703 manufactured by AUTRONIC-MELCHERS was used as a measurement device.

Liquid crystal compositions of Comparative Example 4 (LC-D), Comparative Example 5 (LC-E), and Comparative Example 6 (LC-F) were prepared, and the physical property values thereof were measured. The configurations of the liquid crystal compositions and the results of the physical property values are as shown in Table 2.

TABLE 2

| | Compar- | Compar- | Compar- |
|---|---|---|---|
| | ative | ative | ative |
| | Example 4 | Example 5 | Example 6 |
| | LC-D | LC-E | LC-F |
| 3-Cy-Cy-2 | 18 | 18 | 10 |
| 3-Cy-Cy-4 | 8 | | |
| 3-Cy-Cy-V | | | 16 |
| 3-Cy-Cy-V1 | | 8 | |
| 3-Cy-Ph—O2 | 4 | 4 | 4 |
| 3-Ph—Ph-1 | 11 | | 11 |
| 5-Ph—Ph-1 | | 11 | |
| 3-Cy-Ph—Ph-1 | | | |
| 3-Cy-Ph—Ph-2 | 10 | 10 | 10 |
| 3-Cy-1O—Ph5—O1 | 4 | 4 | 4 |
| 3-Cy-1O—Ph5—O2 | 7 | 7 | 7 |
| 2-Cy-Cy-1O—Ph5—O2 | 5 | 9 | 9 |
| 3-Cy-Cy-1O—Ph5—O2 | 5 | 9 | 9 |
| 1V-Cy-Cy-1O—Ph5—O2 | 8 | | |
| 2-Cy-Ph—Ph5—O2 | 5 | 5 | 5 |
| 3-Cy-Ph—Ph5—O2 | 5 | 5 | 5 |
| 3-Cy-Ph—Ph5—O3 | 5 | 5 | 5 |
| 3-Cy-Ph—Ph5—O4 | 5 | 5 | 5 |
| Total [%] | 100 | 100 | 100 |
| Tₙᵢ | 78.8 | 78.7 | 75.8 |
| Δn | 0.112 | 0.111 | 0.112 |
| Δε | −3.1 | −3.2 | −3.1 |
| γ₁ | 125 | 132 | 114 |
| K₃₃ | 14.5 | 14.9 | 14.0 |
| γ₁/K₃₃ | 8.6 | 8.9 | 8.1 |

It was found that Comparative Example 4 (LC-D) has high Tₙᵢ, large Δn, negative Δε, small γ₁, large K₃₃, and small γ₁/K₃₃, but exhibits a significantly low VHR(UV) of 86%. A liquid crystal display device using this was confirmed to have a display defect due to the low VHR(UV).

It was found that Comparative Example 5 (LC-E) has larger γ₁/K₃₃ than that of Example 1 (LC-1) and exhibits a significantly low VHR(UV) of 84%. A liquid crystal display device using this was confirmed to have a display defect due to the low VHR(UV). It was found that Comparative Example 6 (LC-F) has small γ₁/K₃₃ but exhibits a VHR(UV) of as significantly low as 77%. A liquid crystal display device using this was confirmed to have a display defect due to the low VHR(UV).

A polymerizable compound-containing liquid crystal composition was prepared by adding 0.3% by mass of a polymerizable compound represented by the formula (RM-1) (in the formula, R^{M1} and R^{M2} each represent a methyl group) to 99.7% by mass of the liquid crystal composition of Comparative Example 4 (LC-D), and a PSA-mode liquid crystal display device was formed. As a result, it was confirmed that a display defect such as alignment unevenness slightly occurs, and fast response is exhibited. It was also confirmed that the amount of polymerizable compound remaining in the PSA-mode liquid crystal display device is 130 ppm. In addition, VHR(UV) was a value of as low as 89%.

A polymerizable compound-containing liquid crystal composition was prepared by adding 0.3% by mass of a polymerizable compound represented by the formula (RM-1) (in the formula, R^{M1} and R^{M2} each represent a methyl group) to 99.7% by mass of the liquid crystal composition of Comparative Example 5 (LC-E), and a PSA-mode liquid crystal display device was formed. As a result, it was confirmed that a display defect such as alignment unevenness slightly occurs, and fast response is exhibited. It was also confirmed that the amount of polymerizable compound remaining in the PSA-mode liquid crystal display device is 150 ppm. In addition, VHR(UV) was a value of as low as 88%.

A polymerizable compound-containing liquid crystal composition was prepared by adding 0.3% by mass of a polymerizable compound represented by the formula (RM-1) (in the formula, R^{M1} and R^{M2} each represent a methyl group) to 99.7% by mass of the liquid crystal composition of Comparative Example 6 (LC-F), and a PSA-mode liquid crystal display device was formed. As a result, it was confirmed that a display defect such as alignment unevenness slightly occurs, and fast response is exhibited. It was also confirmed that the amount of polymerizable compound remaining in the PSA-mode liquid crystal display device is 230 ppm. In addition, VHR(UV) was a value of as low as 82%.

As a result of measurement of a change in the pretilt angle of each of Comparative Example 4 (LC-D), Comparative Example 5 (LC-E), and Comparative Example 6 (LC-F), the change was 0.5 [°] or more and significantly inferior to the examples. Also, image-sticking was confirmed as a display defect.

A liquid crystal composition of Example 2 (LC-2) was prepared, and the physical property values thereof were measured. The configuration of the liquid crystal composition and the results of the physical property values are as shown in Table 3.

TABLE 3

| | Example 2 |
|---|---|
| | LC-2 |
| 3-Cy-Cy-2 | 22 |
| 3-Cy-Cy-4 | 9 |
| 3-Cy-Ph—O2 | 11 |
| 3-Ph—Ph-1 | 5 |
| 5-Ph—Ph-1 | |
| 3-Cy-Ph—Ph-1 | 5 |
| 3-Cy-Ph—Ph-2 | |
| 3-Cy-1O—Ph5—O1 | |
| 3-Cy-1O—Ph5—O2 | 7 |
| 2-Cy-Cy-1O—Ph5—O2 | 9 |
| 3-Cy-Cy-1O—Ph5—O2 | 9 |
| 2-Cy-Ph—Ph5—O2 | 5 |
| 3-Cy-Ph—Ph5—O2 | 5 |
| 3-Cy-Ph—Ph5—O3 | 5 |
| 3-Cy-Ph—Ph5—O4 | 8 |
| Total [%] | 100 |
| Tₙᵢ | 80.5 |
| Δn | 0.101 |
| Δε | −3.0 |
| γ₁ | 125 |
| K₃₃ | 14.8 |
| γ₁/K₃₃ | 8.4 |

It was confirmed that Example 2 (LC-2) has high Tₙᵢ, large Δn, negative Δε, small γ₁, large K₃₃, and small γ₁/K₃₃, and that a VA-mode liquid crystal display device produced by using the liquid crystal composition of this example exhibits sufficiently high response speed and a VHR(UV) value of as very high as 94%.

A polymerizable compound-containing liquid crystal composition was prepared by adding 0.4% by mass of a polymerizable compound represented by the formula (RM-1) (in the formula, R^{M1} and R^{M2} each represent a methyl group) to 99.6% by mass of the liquid crystal composition of Example 2 (LC-2), and a PSA-mode liquid crystal display device was formed. As a result, it was confirmed that no display defect such as alignment unevenness occurs, and fast response and sufficiently high VHR(V) are exhibited. The VHR(UV) was 95%. Also, the amount of polymerizable compound remaining in the PSA-mode liquid crystal display device was confirmed to be equal to or lower than the detection limit by a HPLC analyzer.

A polymerizable compound-containing liquid crystal composition was prepared by adding 0.4% by mass of a polymerizable compound represented by the formula (RM-2) (in the formula, R^{M1} and R^{M2} each represent a methyl group) to 99.6% by mass of the liquid crystal composition of Example 2 (LC-2), and a PSA-mode liquid crystal display device was formed. As a result, it was confirmed that no display defect such as alignment unevenness occurs, and fast response and sufficiently high VHR(V) are exhibited. The VHR(UV) was 96%. Also, the amount of polymerizable compound remaining in the PSA-mode liquid crystal display device was confirmed to be equal to or lower than the detection limit by a HPLC analyzer.

The PSA-mode liquid crystal display device was produced by ultraviolet irradiation under the irradiation conditions 1 and further ultraviolet irradiation under the irradiation conditions 2.

A liquid crystal composition of Example 3 (LC-3) was prepared, and the physical property values thereof were measured. The configuration of the liquid crystal composition and the results of the physical property values are as shown in Table 4.

TABLE 4

| | Example 3 |
|---|---|
| | LC-3 |
| 3-Cy-Cy-2 | 18 |
| 3-Cy-Cy-4 | 6 |
| 3-Cy-Ph—O2 | |
| 3-Ph—Ph-1 | 10 |
| 3-Cy-Cy-Ph-1 | 6 |
| 3-Cy-Ph—Ph-1 | 7 |
| 3-Cy-Cy-1O—Ph—O2 | 14 |
| 3-Ph—Ph5—Ph-2 | 2 |
| 1-Ph—Ph5—O4 | 10 |
| 3-Ph—Ph5—O2 | 10 |
| 2-Cy-Ph—Ph5—O2 | 5 |
| 3-Cy-Ph—Ph5—O2 | 5 |
| 3-Cy-Ph—Ph5—O4 | 5 |
| 3-Ph-2-Ph—Ph5—O2 | 2 |
| Total [%] | 100 |
| Tₙᵢ | 72.6 |
| Δn | 0.126 |
| Δε | −3.0 |
| γ₁ | 121 |
| K₃₃ | 14.5 |
| γ₁/K₃₃ | 8.3 |

It was confirmed that Example 3 (LC-3) has high Tₙᵢ large Δn, negative Δε, small γ₁, large K₃₃, and small γ₁/K₃₃, and that a VA-mode liquid crystal display device produced by using the liquid crystal composition of this example exhibits sufficiently high response speed and a VHR(UV) value of as very high as 95%.

A polymerizable compound-containing liquid crystal composition was prepared by adding 0.35% by mass of a polymerizable compound represented by the formula (RM-1) (in the formula, R^{M1} and R^{M2} each represent a methyl group) to 99.65% by mass of the liquid crystal composition of Example 3 (LC-3), and a PSA-mode liquid crystal display device was formed. As a result, it was confirmed that no display defect such as alignment unevenness occurs, and fast response and sufficiently high VHR(V) are exhibited. The VHR(UV) was 96%. Also, the amount of polymerizable compound remaining in the PSA-mode liquid crystal display device was confirmed to be equal to or lower than the detection limit by a HPLC analyzer. The PSA-mode liquid crystal display device was produced by ultraviolet irradiation under the irradiation conditions 1 and further ultraviolet irradiation under the irradiation conditions 2.

A polymerizable compound-containing liquid crystal composition was prepared by adding 0.35% by mass of a polymerizable compound represented by the formula (RM-2) (in the formula, R^{M1} and R^{M2} each represent a methyl group) to 99.65% by mass of the liquid crystal composition of Example 3 (LC-3), and a PSA-mode liquid crystal display device was formed. As a result, it was confirmed that no display defect such as alignment unevenness occurs, and fast response and sufficiently high VHR(V) are exhibited. The VHR(UV) was 97%. Also, the amount of polymerizable compound remaining in the PSA-mode liquid crystal display device was confirmed to be equal to or lower than the detection limit. An amount of change in the pretilt angle was confirmed to be substantially zero [°].

A polymerizable compound-containing liquid crystal composition was prepared by adding 0.35% by mass of a polymerizable compound represented by the formula (RM-4) (in the formula, R^{M1} and R^{M2} each represent a methyl group) to 99.65% by mass of the liquid crystal composition of Example 3 (LC-3), and a PSA-mode liquid crystal display device was formed. As a result, no display defect such as alignment unevenness occurred, and fast response was exhibited. Also, the amount of polymerizable compound remaining was equal to or lower than the detection limit, and the change in the pretilt angle was substantially zero [°]. The VHR(UV) was 96%.

1. A liquid crystal composition with negative dielectric anisotropy, comprising a compound of formula (B31) and a compound of formula (CB31).

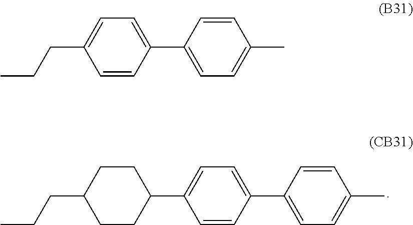

2. The liquid crystal composition according to claim 1, comprising one or two or more compounds selected from a compound group represented by general formula (N-01), general formula (N-02), general formula (N-03), and general formula (N-04), 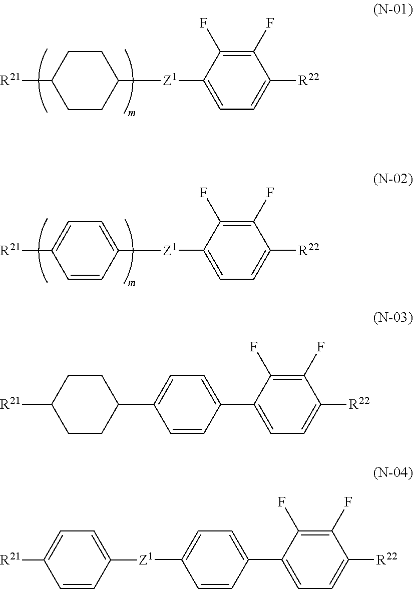
(in the formulae, R²¹ and R²² each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; Z¹ each independently represent a single bond, —CH₂CH₂—, —OCH₂—, —CH₂O—, —COO—, —OCO—, —OCF₂—, —CF₂O—, —CH═CH—, —CF═CF—, or —C≡C—; and m each independently represent 1 or 2).

3. The liquid crystal composition according to claim 1, comprising one or two or more compounds selected from a compound group represented by general formula (NU-01) to general formula (NU-06), 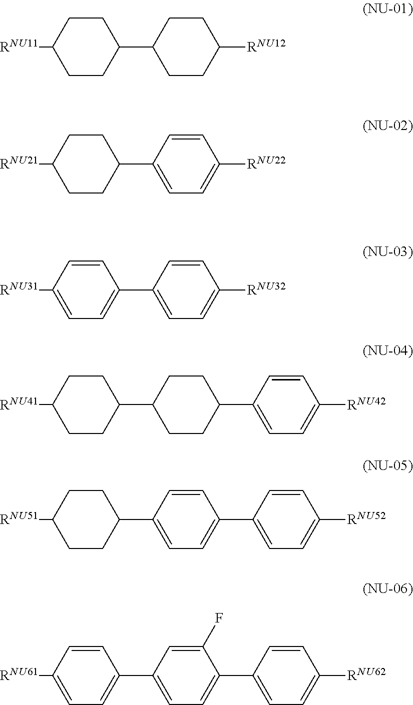
(in the formulae, R^{NU11}, R^{NU12}, R^{NU21}, R^{NU22}, R^{NU31}, R^{NU41}, R^{NU42}, R^{NU51}, R^{NU61}, and R^{NU62} each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—; and R^{NU32} and R^{NU52} each independently represent an alkyl group having 2 to 8 carbon atoms, an alkoxy group having 1 to 8 carbon atoms, an alkenyl group having 2 to 8 carbon atoms, or an alkenyloxy group having 2 to 8 carbon atoms, in which one or two or more unadjacent —CH₂— in the group may be independently substituted by —CH═CH—, —C≡C—, —O—, —CO—, —COO—, or —OCO—).

4. The liquid crystal composition according to claim 1, wherein the total content of compounds having an alkenyl group is 0% by mass to 5% by mass.

5. The liquid crystal composition according to claim 1, comprising one or two or more compounds having a terphenyl structure or tetraphenyl structure and a dielectric anisotropy Δε more than +2.

6. The liquid crystal composition according to claim 1, wherein the total content of compounds selected from compounds represented by the formula (B31), the formula (CB31), the general formula (N-01), the general formula (N-02), the general formula (N-03), the general formula (N-04), the general formula (N-05), the general formula (N-06), the general formula (NU-01), the general formula (NU-02), the general formula (NU-03), the general formula (NU-04), the general formula (NU-05), and the general formula (NU-06) is 95% by mass to 100% by mass, 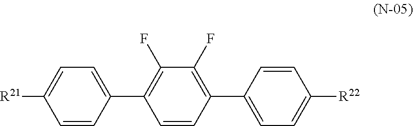
(in the formulae, R²¹ and R²² each represent the same meaning as described above) 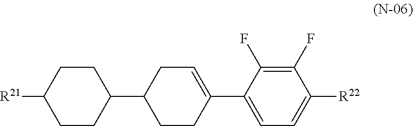
(in the formulae, R²¹ and R²² each represent the same meaning as described above).

7. The liquid crystal composition according to claim 1, comprising one or two or more compounds represented by general formula (RM), 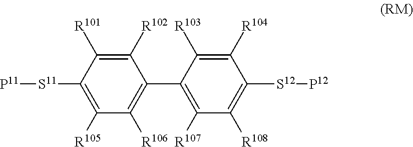
(in the formula, R¹⁰¹, R¹⁰², R¹⁰³, R¹⁰⁴, R¹⁰⁵, R¹⁰⁶, R¹⁰⁷, and R¹⁰⁸ each independently represent P¹³—S¹³—, an alkyl group having 1 to 18 carbon atoms, which may be substituted by a fluorine atom, an alkoxy group having 1 to 18 carbon atoms, which may be substituted by a fluorine atom, a fluorine atom, or a hydrogen atom; P¹¹, P¹², and P¹³ each independently represent a group selected from formula (Re-1) to formula (Re-9) 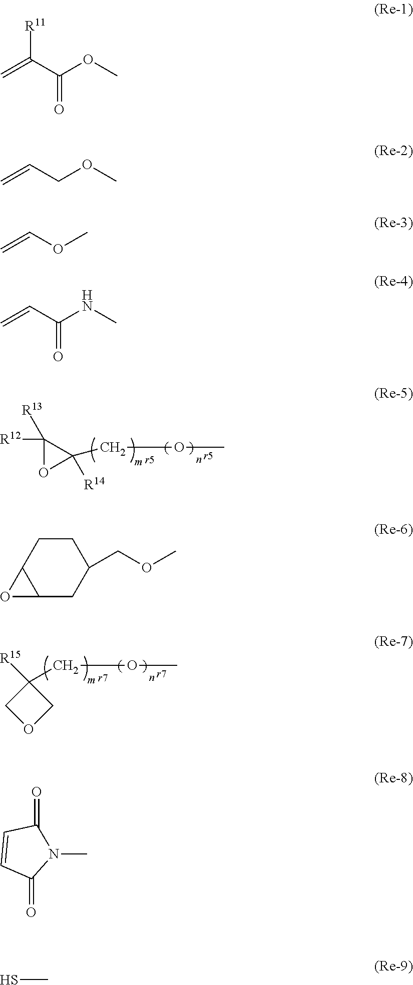
(R¹¹, R¹², R¹³, R¹⁴, and R¹⁵ each independently represent an alkyl group having 1 to 5 carbon atoms, a fluorine atom, or a hydrogen atom; and m^{r5}, m^{r7}, n^{r5}, n^{r7} each independently represent 0, 1, or 2; S¹¹, S¹², and S¹³ each independently represent a single bond or an alkylene group having 1 to 15 carbon atoms, in which one —CH₂— or two or more unadjacent —CH₂— in the alkylene group may be independently substituted by —O—, —OCO—, or —COO— so that oxygen atoms are not directly adjacent to each other; and when there are a plurality of P¹³ and S¹³, they may be the same or different).

8. A liquid crystal display device comprising the liquid crystal composition according to claim 1.

9. A liquid crystal display device for active matrix driving, comprising the liquid crystal composition according to claim 1.

10. A VA-mode, PSA-mode, PSVA-mode, PS-IPS-mode or PS-FFS-mode liquid crystal display device comprising the liquid crystal composition according to claim 1.
